(19) United States
(12) Patent Application Publication
(10) Pub. No.: US 2008/0052203 A1
(43) Pub. Date: Feb. 28, 2008

(54) Design and management of an online environment that serves hierarchical community networks

(76) Inventors: David Beyer, Los Altos Hills, CA (US); Darren Lancaster, Campbell, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/592,600

(22) Filed: Nov. 3, 2006

Related U.S. Application Data
(60) Provisional application No. 60/840,484, filed on Aug. 25, 2006.

(51) Int. Cl. G06Q 10/00

(52) U.S. Cl. 705/28

(57) ABSTRACT

An online environment for creating community networks using a hierarchical architecture to create groups in a given community network where users can organize and manage activities, communications, and payments, and develop links to other groups, and develop mutually-beneficial relationships with merchants in the local or group-related communities is described.

### CROSS-REFERENCE TO RELATED APPLICATIONS; PRIORITY CLAIM

This application claims benefit of Provisional Application 60/840,484, filed Aug. 25, 2006, by David Beyer and Darren Lancaster the entire contents of which is hereby incorporated by reference as if fully set forth herein, under 35 U.S.C. §119(e).

### TECHNICAL FIELD

The present invention relates to Internet web sites, and more specifically to aspects of an online environment that serves hierarchical community networks.

### BACKGROUND

Community networks such as groups, clubs, community organizations, and schools begins with a top-level “domain” that defines the membership and administration for the group. The community network also includes one or more sub-groups that comprise member subsets of the top-level domain. Each sub-group has a manager(s) or coordinator(s). Such a community network is herein referred to as a group domain. Typically, though not always, the membership of a sub-group is a subset of the parent group.

A great deal of time and effort is expended on logistics of group leadership, communication, and organization by a group's members. The time required to create, organize, and attend a group event or activity becomes the limiting factor on an individual's ability to volunteer or participate more broadly in the groups, and/or on the individual's ability to join new groups. As a result, a number of different procedures, tools, and methods have evolved to help groups increase the efficiency of group and activity management.

However, such solutions have a number of limitations that inhibit broad adoption by a given group domain (parent groups and associated sub-groups). In most cases, solutions are adopted and utilized by a localized or singular sub-group, rather than by the entire group domain.

For example, one limitation to some of the current solutions is the inability of the group to establish the identity, behavior, and appearance of the group domain within the solution.

In addition, existing solutions are not amenable to emulating a group's hierarchical organizational structure. For example, if a large organization such as Kiwanis International would like to use an online solution for improved group management and communication, the organization would need to implement an “instance” or group domain of the online solution for each level in the organization's hierarchy. In other words, separate group domains must be created at the multi-national, national, regional, and local levels of Kiwanis International with no linkage or sense of hierarchy between each domain. Thus, each sub-group in the hierarchy is unable to leverage the existence of “parent” groups in the organization.

In view of the foregoing, an online environment for creating community networks by leveraging the attributes of parent groups is needed.

### BRIEF DESCRIPTION OF THE DRAWINGS

FIG. 1 illustrates a community network and organizational hierarchy or architecture.

FIG. 2 is a sample illustration of a school's organizational hierarchy.

FIG. 3 is a sample illustration of a soccer league's organizational hierarchy.

FIG. 4 presents an abstract view of components of an online environment for creating and managing community networks, according to certain embodiments.

FIG. 5 presents a hierarchical architecture and associated group member roles of an instance of the online environment, according to certain embodiments.

FIG. 6 illustrates an example of a basic member directory view, according to certain embodiments.

FIG. 7 illustrates an example of an extended member directory view, according to certain embodiments.

FIG. 8 illustrates an example of a user home dashboard, according to certain embodiments.

FIG. 9 is an example of a Payment Request form, according to certain embodiments.

FIG. 10 is an example of a Payment Request Summary View, according to certain embodiments.

FIG. 11 is an example of a Payment Request Summary View for an individual and/or family, according to certain embodiments.

FIG. 12-13 is an example of an Order form associated with a payment request, according to certain embodiments.

FIG. 14 illustrates the object hierarchy associated with online payments, according to certain embodiments.

FIG. 15 illustrates details of the Group Request Object, according to certain embodiments.

FIG. 16 illustrates details of the Group Payment Request Object, according to certain embodiments.

FIG. 17A illustrates a scenario where the Payment Service utilizes Virtual Transaction Accounts to process user payments, according to certain embodiments.

FIG. 17B illustrates a scenario where one or more Payment Service vendors with payment gateway capabilities are used to process user payments, according to certain embodiments.

FIG. 18 illustrates the GoLocal and GroupReward features, according to certain embodiments.

FIG. 19 illustrates a “Supporting Merchants Ad” pane, according to certain embodiments.

### DETAILED DESCRIPTION

Methods, systems, user interfaces, and other aspects of the invention are described. Reference will be made to certain embodiments of the invention, examples of which are illustrated in the accompanying drawings. While the invention will be described in conjunction with the embodiments, it will be understood that it is not intended to limit the invention to such embodiments. On the contrary, the invention is intended to cover alternatives, modifications and equivalents that are within the spirit and scope of the invention. The specification and drawings are, accordingly, to be regarded in an illustrative rather than a restrictive sense.

Moreover, in the following description, numerous specific details are set forth to provide a thorough understanding of the present invention. However, it will be apparent to one of ordinary skill in the art that the invention may be practiced without these particular details. In other instances, methods, procedures, components, and networks that are well known to those of ordinary skill in the art are not described in detail to avoid obscuring aspects of the present invention.

### Overview

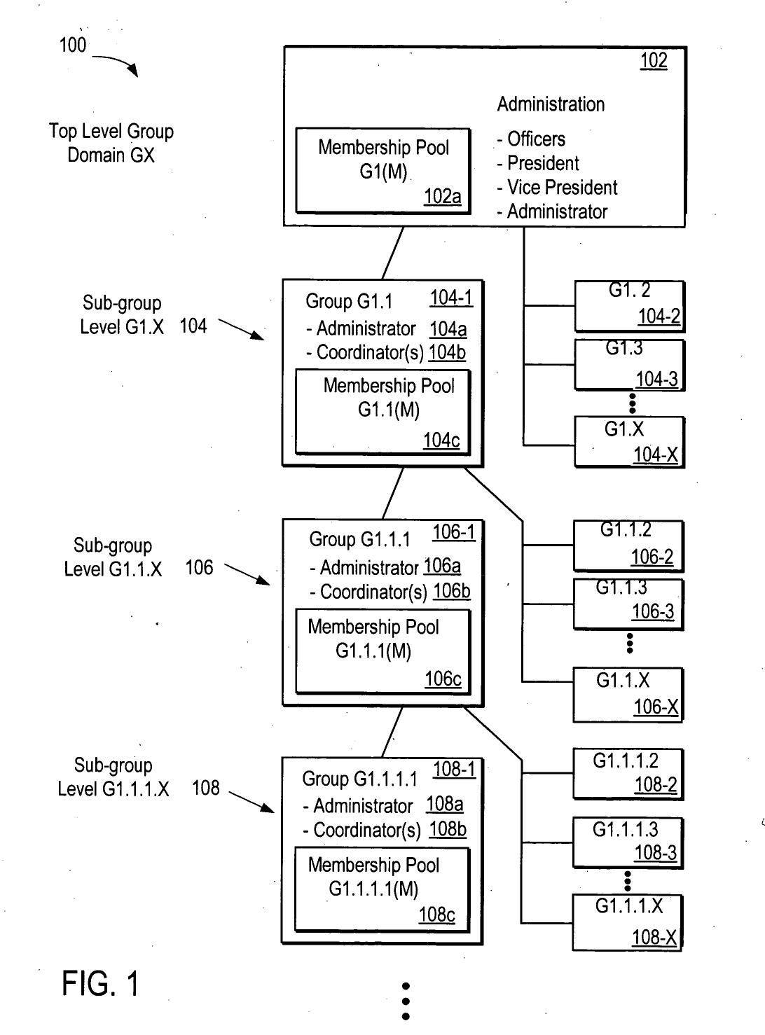

FIG. 1 illustrates a community network and organizational hierarchy or architecture. The membership of a sub-group is a subset of the parent group. Thus, the membership at an arbitrary sub-group level can be represented as GX(M)>=GX.n(M) where GX represents some group at an arbitrary level.

FIG. 1 shows a group domain 100 with a top level group 102 and a plurality of levels of sub-groups such as 104, 106, 108, . . . , etc. Each sub-group level may include one or more groups. For example, sub-group level 104 includes groups 104-1, 104-2, . . . , 104-X, etc. Each group may include one or more administrators 104a, one or more coordinators 104b, and a membership pool 104c, for example.

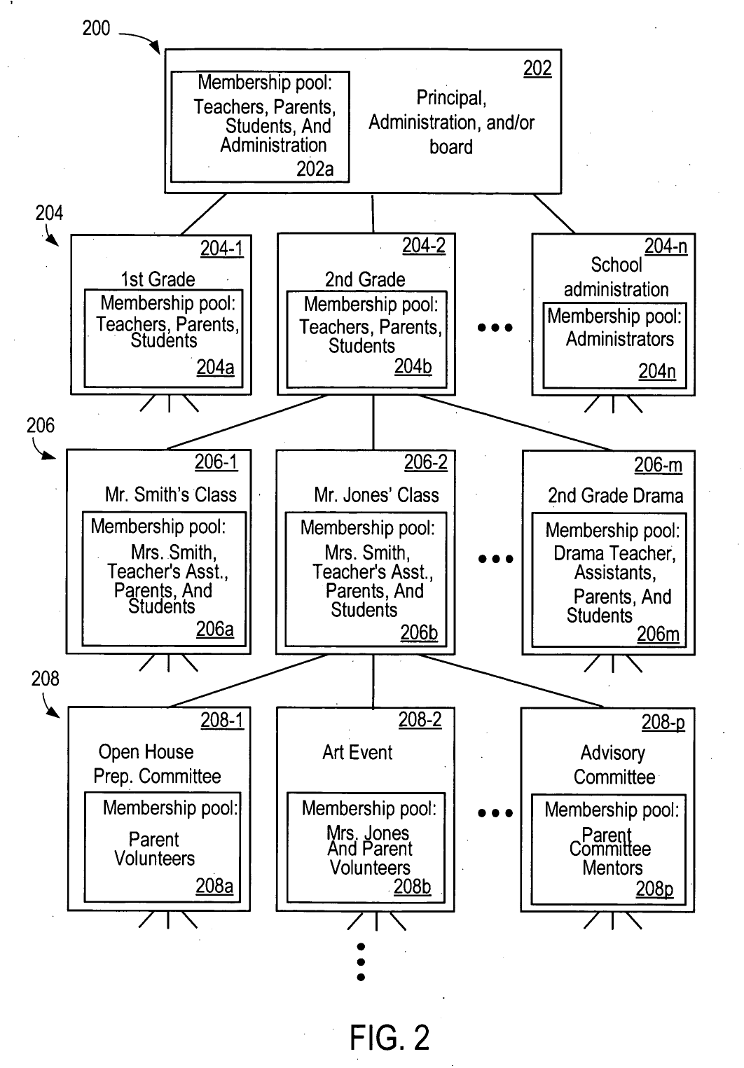

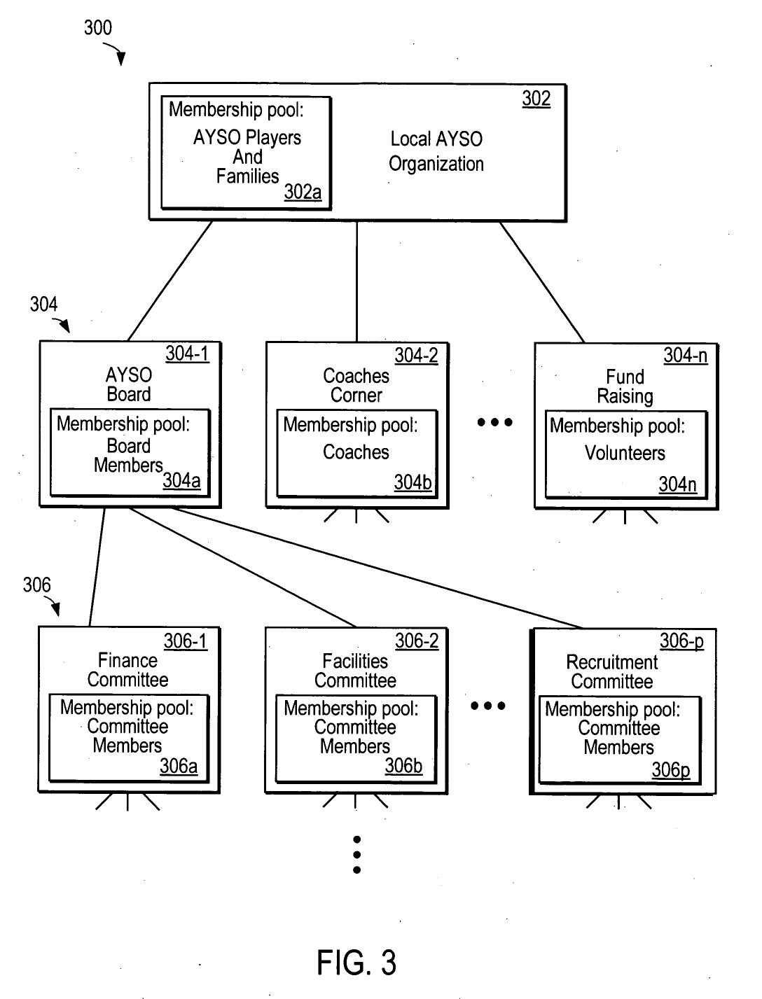

Some other examples of community networks or groups are illustrated in FIG. 2 and FIG. 3. FIG. 2 is a sample illustration of a school's organizational hierarchy. FIG. 2 shows a group domain 200 that includes a top level group 202 and lower level sub-groups such as sub-groups 204, 206 and 208, etc. Examples of sub-groups for the school organization include groups in different grade levels, committees, and groups that are associated with various school events. The top-level group and the sub-groups show respective membership pools, such as membership pools 202a, 204a, 204b, . . . , 204n, 206a, 206b, . . . , 206m, 208a, 208b, . . . , 208p, etc. For example, a membership pool can include teachers, parents and students.

Similarly, FIG. 3 is a sample illustration of a local soccer league organizational hierarchy. FIG. 3 shows a soccer league group domain 300 that includes a top level group 302 and sub-group levels such as sub-group levels 304, 306, 308, etc. As an example, the top level group is the local AYSO Organization. Examples of sub-groups include the AYSO Board 304-1 with a membership pool 304a, coaches group 304-2 with a membership pool 304b, fund raising group 304-n with a membership pool 304n, finance committee 306-1 with a membership pool 306a, facilities committee 306-2 with a membership pool 306b and a recruitment committee 306-p with a membership pool 306p, etc.

For convenience of explanation, the following terms are used herein to describe community networks and group hierarchy:
User or Users: a person or persons who have joined the online environment or have been granted access to the online environment. Such persons may or may not be Members of one or more Groups or Group Domains. A person may become a user by either requesting a user account or being granted a user account within the online environment. Also, a person may become a user by either requesting membership or being granted membership within a Group or Group Domain. A user pool includes users of the online environment.
Member or Members: a person or persons who have joined or been granted access to an organization or community network. The term applies to persons who have been granted access, and who typically participate in a particular Group with a Group Domain, as well as to persons who have been admitted into a Group Domain. Thus, members include members of a Group and members of a Group Domain, according to certain embodiments.
Group Domain: an entire organizational or community network hierarchy and its associated groups and members, content, tools and attributes.
Group: the key unit within a Group Domain comprising members, content, tools & attributes. A Group may optionally have a parent group and/or one or more sub-groups. Groups with no parent group are called “top-level groups.”
Sub-group: a group within a Group Domain and that has a parent and optionally, one or more sub-groups associated with it. The term also refers to the sub-group's members, content, tools and attributes.
Top-level Group: the highest group in a Group Domain hierarchy that has no parent groups associated with it. The term also refers to the members, content, tools and attributes of the top-level group. Group Sub-tree: a Group and all sub-groups below it within a Group Domain hierarchy, and includes the members, content, tools and attributes.
Sub-group Sub-tree: a Sub-group and all sub-groups below it within a Group Domain hierarchy, and includes the members, content, tools and attributes.

According to certain embodiments, the online environment (website) is hosted by a service provider, and allows various types of groups to create their own Group Domain within the website in order to organize and manage the group's activities, communications, and payments. The embodiments are applicable for use by various types of groups, including online and offline community networks, clubs, professional organizations, schools, churches, community groups, and so on. The embodiments can be customized to fit the needs and identities of the particular types of groups or organizations.

According to certain embodiments, the online environment for creating community networks may include the following tools and features:
Administration, management, and support tools for Groups and Users
Administration, management, and support tools for Groups to perform self-management
Payment requests, execution, and transaction reporting tools
Member profile viewing and management
Email lists and exploders
Forums and blogs
Voting and polling capabilities
Document and multimedia data storage
Managing group activities and events in a calendar

There are a number of ways that the embodiments can be offered to end users and groups as a service. An embodiment can be hosted and offered by a service provider that has developed the embodiments, for example. The developer of the embodiments may sell or license the embodiments to one or more solution providers that may host and offer the service to groups. As another example, a vendor with rights to the embodiments may offer the service to groups but utilize a third party service provider to host and provide support for the service. For purposes of explanation, the term “service provider” is used to indicate an entity that owns the rights to some of the embodiments and that offers the associated service to groups with or without the assistance of a third party for hosting and support services. The term “service” relates to the service being offered by the service provider that is utilizing an embodiment, and is used interchangeably with the term “embodiment”. Also, the term “online environment” is used interchangeably with the term “embodiment.”

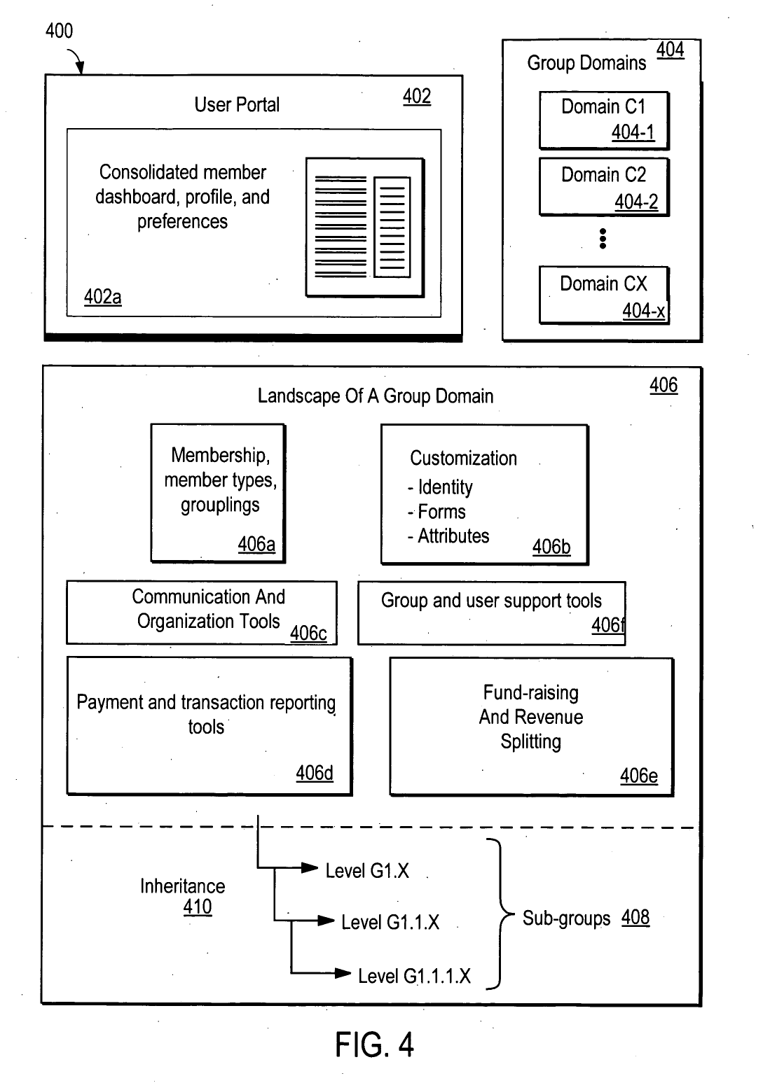

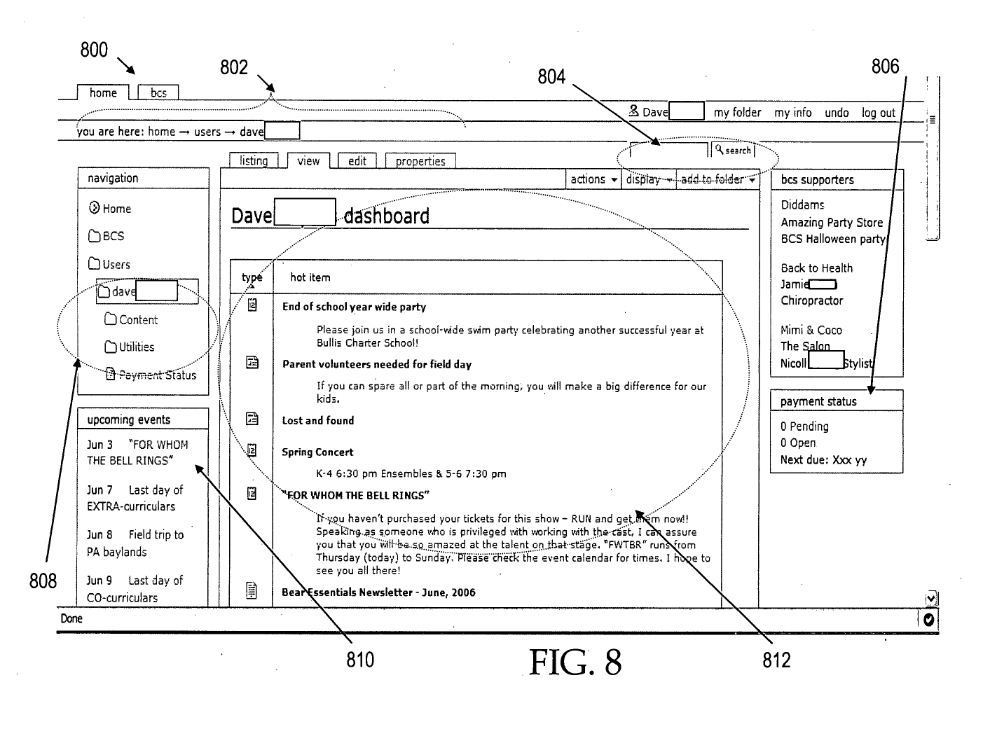

The embodiments support group hierarchy, inheritance of group attributes, membership and identity, payment handling and group financial tools, customization tools for the Group Domains, revenue splitting with participating groups, and user support for multiple group membership with consolidated dashboard views via a single online portal. Further, the embodiments support a number of methods for improved group fund-raising solutions, support building mutually beneficial relationships between groups and local merchants, and support ways for groups and a website owner to collaborate on the filtering and approval of online advertisements and promotions. An abstract diagram of the landscape of certain embodiments is shown in FIG. 4. FIG. 4 shows a user portal 402, group domains 404 and a landscape 406 of a given group domain. A user may use user portal 402 to access any of the group domains 404-1, 404-2, . . . , 404-x of which the user is a member. The user may use a consolidated member dashboard to view information from the various group domains of which the user is a member. The consolidated member dashboard is described in greater detail herein with reference to FIG. 8. According to certain embodiments, landscape 406 of a group domain may include membership and profile information 406a, customization features 406b, communication and organization tools 406c, Group and user support tools 406f, payment and transaction reporting tools 406d, and fund-raising and revenue splitting feature 406e. Landscape 406 also shows the inheritance feature 410 by which sub-groups 408 can inherit membership, content, tools and attributes from parent groups.

According to one aspect of certain embodiments, groups in a Group Domain are able to establish their own identity, behavior, and appearance of the Group Domain within the online environment. According to another aspect of certain embodiments, customization is possible to enable the group to control: 1) the manner in which content is published within the online environment, 2) policies for member and content management, 3) processes and tools for group and user support, 4) the look-and-feel for the group calendar, and so on.

According to yet another aspect, the online environment for creating community networks allows sub-groups to inherit or leverage the identity, attributes, membership, and support mechanisms that are created by a parent group. Thus, the online environment enables a rapid and secure way for a sub-group to establish itself within a Group Domain.

According to certain embodiments, an individual user does not need to create a new identity or membership within each separate Group Domain. Instead, the user can view or act in any Group Domain in the online environment as long as the user is a member of the particular Group Domain in which he wishes to act or view. In other words, the user can use a single identity or login information in order to access an aggregated or consolidated view of multiple Group Domains of which the user is a member. The benefits and time savings of such a feature are significant. For purposes of illustration, assume that a parent has two children active in the following school groups: the local elementary school, 1^{st} grade classroom, 2^{nd} grade classroom, band, 2^{nd} grade drama, 2^{nd} grade field trips (for which the parent volunteers to help), 1^{st} grade parent assistants, and a school soccer team. It would be useful for the parent to login to an online environment that provides an aggregated calendar that displays all of the relevant events, associated with the above school groups, occurring within the next day, week, or month. Also, a family is likely to be involved in groups outside of the school domain, such as a youth soccer league, community service organizations such as Kiwanis or Rotary International, and other ad-hoc community groups such as a town parade committee. The aggregation of events, news and other communications from these various groups to an individualized, consolidated view are possible, according to certain embodiments. When an individual(s) or member(s) has an aggregated view of activities for multiple groups, and has the ability to register and make any required payments for the activities, increased efficiency is realized by the member(s) and groups alike.

Further, according to another aspect of certain embodiments, groups and sub-groups can set-up activities, request payments, collect and track payments, and generate transaction and payment request summary reports using the online environment.

Fund-raising is an active area for many groups. For purposes of illustration, assume that, in a co-sales fund-raising effort, the groups are the “foot soldiers” that sell and/or promote one or more advertising and marketing products offered by the online environment to merchants in order to reap a share of the sales revenue transacting between merchants and the online environment. In other cases, groups explore a win-win-win relationship with local merchants, where the group members purchase services or goods from the merchant who has agreed to give a certain percentage of the revenue back to the group. In this case the online environment facilitates the marketing of the reward sharing being offered by the merchant. The online environment also facilitates the transfer of revenues from the merchant to the participating groups. This is a win for the group that receives the fund-raising revenue, a win for the merchant as an opportunity to market itself and expand its customer base, and also a win for the members who are supporting a “well-intended” merchant and their group simultaneously. Thus, the online environment facilitates the win-win-win relationship between groups, the groups' members, and local merchants, and dramatically reduces the effort required of the participants. Such embodiments assist the fund-raising needs of a group, help a merchant market to and expand its customer base, and create strong relationships in the local community. A revenue sharing relationship between the online environment provider and the groups, where the marketing and advertising revenues are shared, will greatly enhance the win-win relationship.

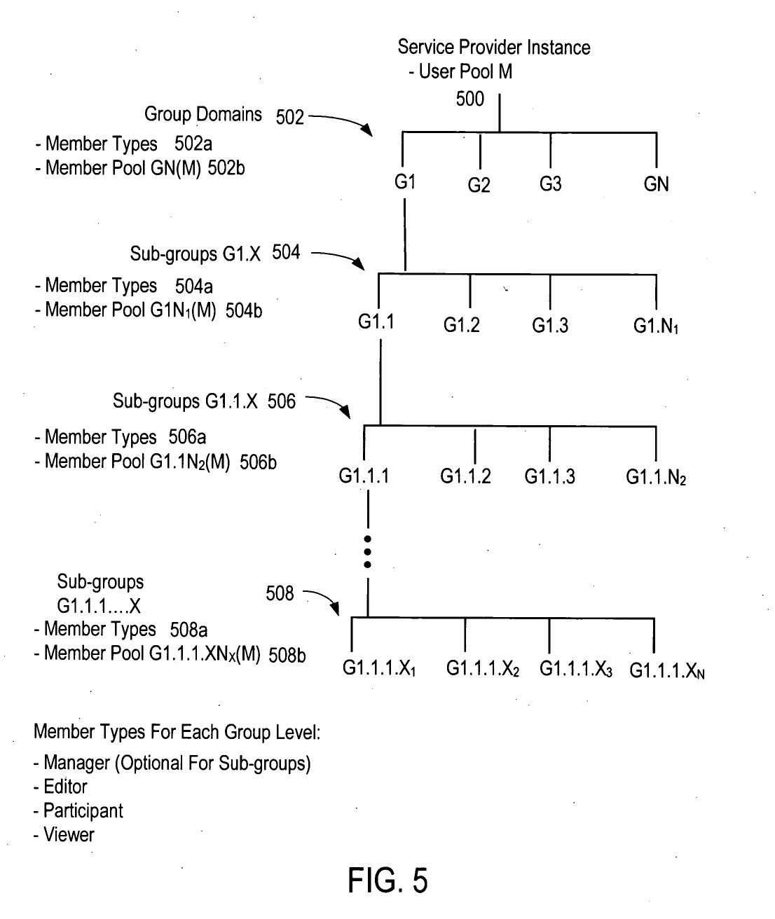

The embodiments support the hierarchy, roles, policies, and relationships that occur in most group instances. The hierarchy and group member roles in certain embodiments are illustrated in FIG. 5. For example, a service provider creates an instance 500 of the hosted online environment and has an arbitrary number of unique users (user pool 500a), each with their own identity and a secure login to a user portal. An arbitrary number of top-level Group Domains 502 exist at the second level of the architecture, under the service provider instance 500. The membership pool in each Group Domain may be a subset of the user pool 500a of the hosted online environment, according to certain embodiments. Group Domains 502 can include defined user roles 502a and a membership pool 502b. A Group Domain may include any number of sub-groups such as sub-groups at levels 504, 506 and 508. Each sub-group may include defined user roles such as user roles 504a, 506a, 508a and member pools such as member pools 504a, 506b, 508c. Non-limiting examples of user roles include group manager, editor, participant and viewer.

The sample roles illustrated in FIG. 5 are shown in greater detail in TABLE 1 below. TABLE 1 shows the access rights for each role, according to certain embodiments. TABLE 1 also shows examples of roles in real-life groups that correspond to the roles in the various groups in a given Group Domain. In TABLE 1, access rights increase from top (viewer) role to bottom (manager) and each successive role inherits the access rights for the preceding role (e.g., participants have the same access rights as a viewer plus some expanded rights).

TABLE 1

| Role | Access Rights For: | Types of people |
|---|---|---|
| Viewer | Read, watch, listen, search the content | Group domain |
| | Subscribe to content summaries, monitor a chat or | member (not |
| | video conference | necessarily part of |
| | View poll results, calendar events and personalized views | sub-group) |
| | Create a copy of the content (e.g., to fill in a form) | Guest |
| Participant | Participate in a chat or teleconference, add comments | Group member |
| | View & respond to payment requests | |
| | Invitee of calendar events | |
| | Vote in the poll | |
| Editor | Edit base content, poll question, moderate (accept or | Group lead or |
| | reject) comments | coordinator |
| | Add tags & keywords to the content | Committee leader |
| | Define & schedule “live” content (chat, call, conference) | Volunteer |
| | Create content & subgroups within a folder. In order | |
| | to create a new object, the individual must have at | |
| | least an Editor role for that folder | |
| Manager | Manage the group's web domain identity and URL(s) | Group officer |
| | (Group domain only) | Administration |
| | Accept requests or directly promote content being | Group lead or |
| | placed in the public access area of the group | coordinator |
| | Set or modify member access roles and rights | |
| | Set or modify content access rights | |
| | Delete content objects | |
| | Offer the content to another group owner (move, copy, | |
| | or link), by sending automated email to the other | |
| | owner, and publish content for subscriptions | |
| | Create administrative sub-groups and group | |
| | management tools, such as those associated with | |
| | Accounting, Support (group and member), and | |
| | Merchant Management | |
| | Offer, accept requests for, and manage group | |
| | membership, including the removal of members, or | |
| | allocate these permissions to a Member Manager | |
| | Administer payment requests approvals, refunds, and | |
| | reimbursements or allocate these permissions to an | |
| | Accounting Manager | |
| | Approve, reject, and filter merchants and particular | |
| | merchant advertising, or allocate these permissions to | |
| | a Merchant Manager | |
| | Configure group home dashboard including default | |
| | views and available panes | |

Each Group Domain usually has at least one member designated as the manager. For purposes of explanation, the terms “Group Domain Manager” or “Administrator” are used to refer to one or more members designated as the Manager at the Group Domain level. Such a member usually has the broadest privileges within the group for managing the Group Domain. Such privileges include defining the attributes that can be inherited by sub-groups, removal of members and filtering and approving supporting merchants and advertisements within the Group Domain, according to certain embodiments. However, the Group Domain's manager's privileges may vary from one sub-group to another and do not automatically include privileges for editing content within sub-groups, for example. According to certain embodiments, membership in sub-groups is defaulted to a subset of the parent group's membership. However, any member of a Group Domain can be added to the membership of an arbitrary sub-group. Each sub-group layer usually has at least one editor and may have a manager who functions as the group-level coordinator. The manager determines membership for the group, manages group administration, etc. Members may be removed at the discretion of the manager. For example, members may be removed for violating policies instituted by the online environment and/or those instituted by the Group Domain.

Support for hierarchy and inheritance in certain embodiments enable the rapid creation of sub-groups from a parent group, and/or the expansion of a Group Domain by adding and linking a new parent group to an existing sub-group. Apart from being a quicker way to establish or expand a group's domain, support for hierarchy and inheritance also enables a flexible adoption model for certain embodiments. The service associated with an embodiment can be tested, adopted, and customized at an arbitrary point in the group hierarchy. Additional parent or sub-groups can then adopt the service, create a linkage to existing group(s) in the domain, and inherit from the membership pools, identities, payment service tools, support tools, merchant relationships, advertisement filtering, member types and roles, email exploders, and other shared tools and services that have already been created in the online environment of an embodiment. The benefit for the service provider offering the service of an embodiment is the rapid rates of adoption and deeper penetration with a given Group Domain once one group within the domain has agreed to adopt the service. Also, the rate of adoption is increased by parents and other users that are using the service for one Group Domain (such as a school), and then help introduce the service for use in other Group Domains (such as a youth soccer league or town committees).

The characteristics of a Group Domain in certain embodiments parallel the characteristics of a real-life group organization in many ways. For example, the top-level domain of Kiwanis is Kiwanis International. At the Kiwanis International level: 1) the total membership pool for the Kiwanis organization is defined, 2) access to the Kiwanis organizational resources, finances, and roles for its members are established, and 3) non-members are not permitted access to privileged information. A Group Domain instance of Kiwanis International in the online environment of certain embodiments behaves in a similar way. The top-level Group Domain defines the total membership for Kiwanis within the online environment. Non-members are not permitted access to the Kiwanis Group Domain. Thus, the Kiwanis International Group Domain can be considered a “walled-garden” within the service. The Kiwanis manager exclusively controls the authentication and granting of membership to users, according to certain embodiments. The internet URL used to access the Kiwanis Group Domain may be specific, such as: www.Kiwanis-International[service provider].com where “service_provider” refers to the service provider's web domain. Additionally, a group may choose to redirect some or all of a web domain owned by the group to their “walled-garden” Group Domain area within the service provider's website. For example, www.kiwanis-international.net may automatically redirect users to www.Kiwanis-International.[service provider].com.

According to certain embodiments, a number of other components within the online environment combine to create a competitive service offering that can result in broader and deeper adoption of the service by various Group Domains, within a Group Domain, and by individual users. Such components are listed below and discussed in greater detail herein:
Payment tables, handling (optionally including refunds), tracking, and auditing.
Reimbursement processing, handling, tracking, and auditing including an approval process defined by the group.
Graphical, friendly, and customizable views for managing the activities of community groups.
Events and content are presented in a relevant manner based on group/user-defined priority and one or more target dates.
A set of tools for grouping members and for communication amongst members, including tools associated with agents, Grouplings, and email exploders. A set of tools for supporting groups and members within a Group Domain or Group Sub-Tree that can be used by the group for self-support, or by a 3^{rd} party to offer support services to the group.
Support for group fund-raising activities via splitting advertising and promotion revenue and a purchase/reward feature.
Support for a group's ability to filter advertisements and promotions by flagging inappropriate advertisements or merchants within their Group Domain.
A flexible user recruiting and adoption model, wherein users may join the service via a Group Domain or via the top-level online portal and then utilize a single identity to join additional Group Domains.
A user “dashboard” view that consolidates information from all of the user's groups based on a selection method utilizing content date, priority, and group priority settings.
A group “dashboard” view that consolidates information from a group, and possibly from its sub-groups and parent groups, based on a selection method utilizing content date, priority, and group priority settings.

In addition to the components listed above, the following features are offered as part of the online environment, according to certain embodiments.

### Hierarchical Groups, Memberships, Users and Structure

Real-life groups or communities like Kiwanis International, a school, or a sports organization like AYSO are organized into their own Group Domain within the online environment of certain embodiments. A Group Domain functions as an organization's virtual “walled garden” where the group controls and offers secure access to its members. The hierarchy of a Group Domain instance and its associated sub-groups, roles, and membership are illustrated in FIG. 5, as previously explained.

An organization can utilize the online environment to create a new Group Domain at any layer of the existing organization. For example, a local soccer team can establish an AYSO Group Domain in the online environment of certain embodiments for use by their local members. Since an embodiment treats a Group Domain as nothing more than a special type of group that has no parent groups, it is quite simple for the AYSO organization to expand the hierarchy upwards to other local teams, and to the regional level, and eventually to the national level without requiring the creation of a new Group Domain. The top-level group in the organizational hierarchy simply becomes the Group Domain. Each of these levels of the organization would be linked within the online environment of an embodiment based on the hierarchy shown in FIG. 5.

In other cases, an organization may choose to use the online environment of an embodiment to create a top level group and expand to the lower levels of the organization immediately or over time. As an example, an administrator for a local school like Bullis Charter School (BCS) might set-up the BCS Group Domain using the online environment. The administrator would follow the steps below to establish a new Group Domain in the online environment, to perform basic configuration of the Group Domain, and to establish membership and user roles, according to certain embodiments:
Create a Group Domain and configure basic features such as Group Domain name, type of organization, location information, Group Domain site use policy, etc.
Create one or more Group Domain manager accounts. If the user has not previously used the online environment then this step will allow the user to create a user account within the online environment, in addition to creating the Group Domain manager role. The listing other Group Domain managers may trigger an email invitation to the proposed manager(s).
Use an Admissions Tool to create an initial list of Group Domain members either one-by-one or by importing a comma-separated value (CSV) file. Such an action may result in email invitations to be sent to all new persons on the list to join the Group Domain. As each member is confirmed into the Group Domain the member directory is automatically updated.
Establish roles and access rights for members (see TABLE 1), including possibly establishing an Administration sub-group (see TABLE 4).
Optionally establish additional member types and “Grouplings” (lists of members), plus the associated email exploders.
Optionally modify the default settings for which Group Domain attributes, roles, and memberships can be inherited by sub-groups.

As a result of the above steps, the folder structure illustrated in TABLE 2 below is created for the new Group Domain making it functional within the online environment of an embodiment. Subsequent to the creation of the folder structure illustrated in TABLE 2, members with manager or editor access rights within the Group Domain may initiate the creation of sub-groups by following a subset of the steps described above for creating a Group Domain. When establishing a sub-group, the group owner can leverage the Group Domain membership directory to define the sub-group membership and automatically inherit the access rights, roles, attributes, and utilities that have been established at the Group Domain level and by any associated parent groups.

Upon creating a new sub-group, the folder structure for sub-groups illustrated in TABLE 2 is created.

TABLE 2
Folder Structure for Group Domains and Sub-Groups

```
<Service Provider root folder>
    <Group Domain name>
        dashboard
        aggregated view plus shortcuts to key group
utils
        members
    Group directory, mapping, email, chat, forum(s)
        content
        Group content files
            archives
            “Deleted” group content
        administration
    administration sub-groups contents, tools, etc.
        <0 or more subgroup folders>
        <sub-group name>
            dashboard
            members
            content
                archives
            utils
            <0 or more subgroup folders>
```

By creating new sub-groups or even parent groups, a given Group Domain expands and retains the notion of hierarchy depending on where the new group is being created. This ensures that groups can create their own Group Domain within the online environment which accurately and organically reflects the hierarchy present within their organization.

As the Group Domain expands, the online environment's support for inheritance ensures that, by virtue of their location within the hierarchy, groups may “inherit” tools and services that have been added at higher levels in the hierarchy. A good example is the Payment Service. According to certain embodiments, there is a Payment Service present at the top level of a Group Domain, but there may be other payment services added at lower levels of the group hierarchy. In such a case, a group will use the Payment Service that is located at the node that is closest to the group and that is higher up in the hierarchy.

The AYSO example illustrates the online environment's inheritance feature. It is possible that payment processing and handling can be coordinated on a regional basis in most cases. However, in large local markets, it is desirable to process payments at a local level. In such a case, the “AYSO West” region can establish a Payment Service that all organizations in the West can use. However, the local clubs in the San Francisco region (sub-groups to the West region) may have their own Payment Service. Thus, when a user in the “Marina District, 9 year old” sub-group of “San Francisco” submits a payment, the online environment of certain embodiments will automatically look in the “Marina District, 9 year old” sub-group folder for a Payment Service first. If a Payment Service is not found in that sub-group, the service will traverse up the hierarchy to the “San Francisco” sub-group. Since a Payment Service is provided in the “San Francisco” sub-group, such a payment service will be used. If no Payment Service is provided in that sub-group then the Payment Service provided in the “West” region sub-group is used.

In other cases, the inheritance feature provides for the reuse of attributes or tools that have been created by parent groups in the domain hierarchy. For example, the AYSO national organization may wish to create custom icons, graphics, backgrounds, fonts, calendar images and formats, etc., to improve the look-and-feel of their Group Domain and organizational identity. Sub-groups within the AYSO domain may use any attributes made available for inheritance by the Manager(s) to customize group content and views. Thus, the sub-groups' set-up time is vastly reduced. Further, a more consistent identity for the entire organization is created. On the other hand, if Group Domain managers may allow sub-groups to have the ability to create their own look-and-feel and identity, according to certain embodiments.

Once a user is successfully added to a Group Domain as a member, the user becomes a “Domain Member” and will default to a Viewer role within the Group Domain with the associated privileges. The member roles and detailed access rights are listed in TABLE 1, while a sample listing of user terms is shown in TABLE 3, herein. A member's role may be upgraded to Participant, Editor, and Manager roles by a Group Domain manager. As members are added to groups within the Group Domain, the newly added members take on the role of “Group Member”, and will default to the Viewer role. Such members may be upgraded to another role by a group manager. The manager may also modify the default role that users receive at the time the users join a group.

TABLE 3

| User term | Definition & Typical assigned roles |
|---|---|
| Guest (aka | An anonymous user that has not logged into the service provider's |
| “anonymous” | website instance of the online environment of certain embodiments |
| or “public”) | Limited to viewing access only (online environment information pages |
| | and registering for a login account) |
| | By default, guests have no visibility inside (or even of the existence of) |
| | Group domains. Group domain administrators can optionally allow |
| | some guest access by (e.g., for viewing the Group Domain's top-level |
| | home page) by reconfiguring the Group Domain's security policy or |
| | create content designated for “public” availability. |
| Authenticated | A user that has successfully logged into the online environment site. |
| user | In addition to the guest rights, an authenticated user has access to their |
| | own user folder, including their dashboard, user information & |
| | preference data, and home page |
| | Security policies of Group Domains do not distinguish between |
| | “Guests” and “Authenticated Users.” These are all treated as guests |
| | within the Group Domain folders |
| Domain | A user listed as a member of a particular Group Domain. |
| Member (aka | By default, domain members get “Viewer” access rights for the top- |
| Community | level Group Domain folder |
| Member) | |
| Group | A user listed as a member of a (sub-)group within a Group Domain |
| Member | Only Domain Members may be added to the group membership of any |
| | sub-group of that Group Domain. However, the membership lists of |
| | sub-groups are not otherwise limited (e.g., not limited by the |
| | membership list of aparent sub-group) |
| | By default, group members are assigned either Viewer role, or the role |
| | acquired from the closest ancestor group folder of which they are a |
| | group member, whichever provides the greater access rights |
| Owner | The owner of a particular content item or object. Owners are given |
| | Manager rights over that object by default |

As shown in TABLE 1, the role of Viewer is primarily used to limit user's access rights to subscribe to and view content, whereas a Participant role allows a user to actively participate in the group. For example, the participant role allows a user to participate in events, receive and accept payment requests, participate in chat sessions, forums, and polls, and so on. In most cases, members of a group are designated as Participants, while a smaller number of members are designated as Editors. An Editor is a user that has permission to create content within a group context. The Editor automatically becomes the “Owner” of any content item or object that he or she creates. Thus, an Owner has manager-level access rights for content item he created (e.g., the ability to edit, move, and archive the content item).

Prior to a user joining or creating a Group Domain, the user may visit the online environment of an embodiment to learn about the service and request more information. Such persons can browse as “Anonymous” users or logon as “Guest” users. Anonymous and Guest users have no access to Group Domains even as a viewer, unless one or more Group Domains have published content that is outside the “walled garden” and is thus visible to the public. Once a user has created a personal account within the online environment of an embodiment, the user is deemed an “Authenticated user” and can then have access to the user's own user folder, dashboards, preference settings, and so on. However, an authenticated user must still be explicitly added to a Group Domain before the user can gain access to a Group Domain, according to certain embodiments. The Guest and Authenticated User roles are explained in greater detail in TABLE 3, herein.

The online environment of certain embodiments allows an agent or proxy relationship to be established between two or more users to enable the sharing of privileges, roles, and views. In general, the agent relationship between two or more users is established by consent. However, in the case of a minor (a child below the age of 18), the agent relationship between the child's account and one or more adult accounts would likely be established directly by the adults. The linking a number of user accounts within a family is one way to use the agent relationship so that both parents can act on behalf of the children in the family, and also on behalf of the entire family.

The “Groupling” feature is used by the online environment of certain embodiments to store or group members of a similar type as defined either by the group membership or the type of role the member possesses within a Group Domain. Grouplings are a convenient way to manage and communicate with lists of people with common interests, characteristics, or agent relationships. Grouplings can be explained using the Bullis Charter School (BCS) organization example. The BCS group may like to define member types such as “student,” “teacher,” “admin,” “parent” types and thereby create the following Grouplings:
bcs—students
bcs—teachers
bcs—admins
bcs—parents
bcs—others (automatically created)
bcs—all (automatically created, set to union of above list)

Members of a group may belong to more than one Groupling, but must belong to at least one Groupling, according to certain embodiments. If a member is not given any domain-defined type, he or she will be added automatically to the “others” Groupling.

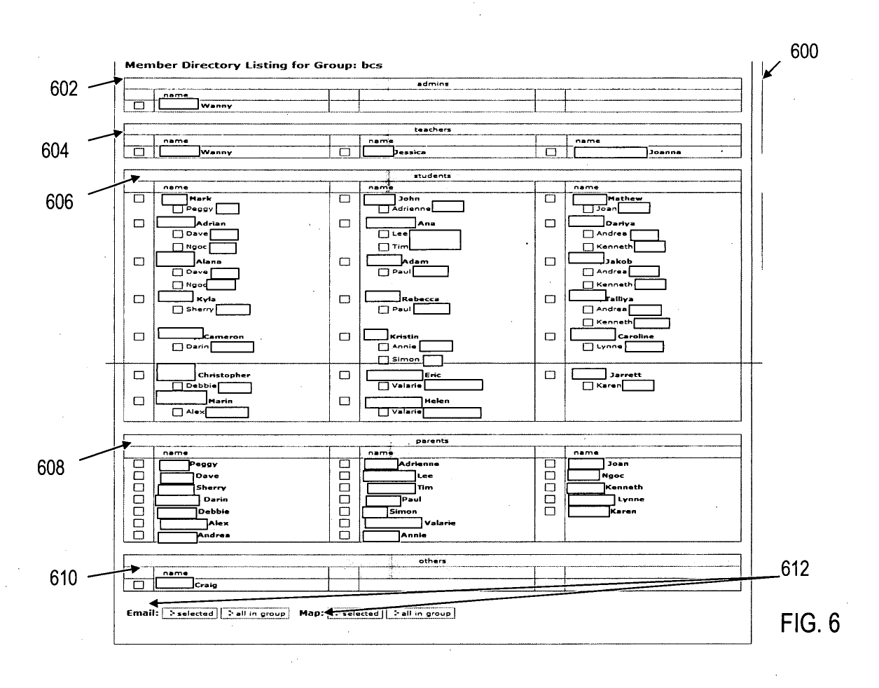

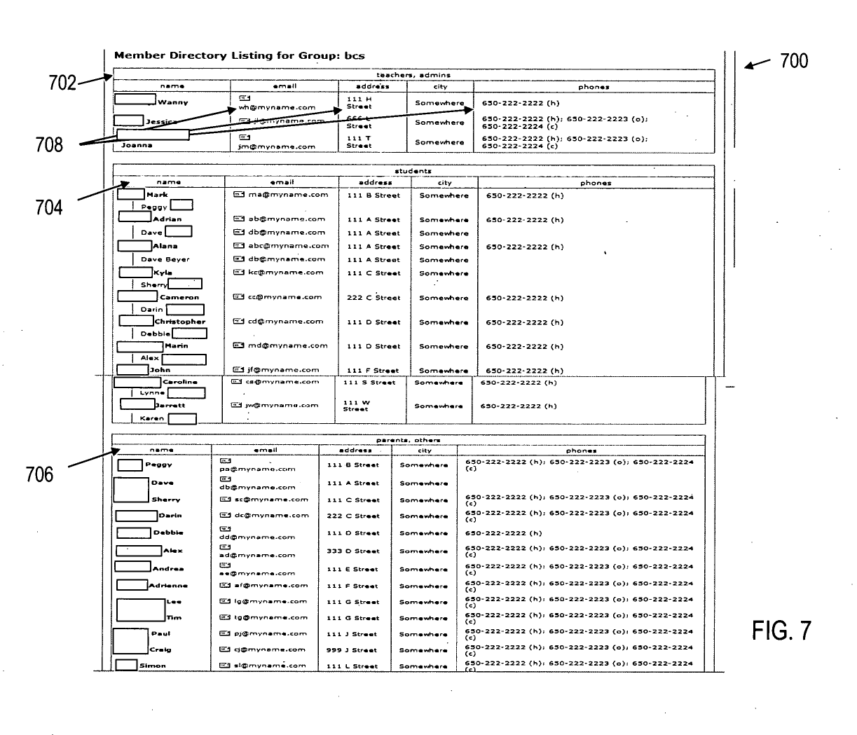

FIG. 6 shows a sample member directory listing 600 for a school group such as the group in the BCS example above. FIG. 6 shows the members in the different roles defined for the group. Member directory listing 600 includes the administrator listing 602, the teacher listing 604, the student listing 606, the parent listing 608 and the “other members” listing 610. Member directory listing 600 may also include an email and/or mapping function 612. FIG. 7 illustrates an example of an extended member directory view 700, according to certain embodiments. The extended member directory view 700 shows a teachers/administrators listing 702, a students listing 704 and a parents/others listing 706. The extended member directory view 700 shows email information, address, telephone numbers, etc., associated with the listed members, according to certain embodiments.

By selecting from the top-level “—all” Groupling (e.g., bcs-all), members can be identified and assigned to the role-oriented Grouplings for the two groups just created, namely, the top level group (e.g., “bcs”) and the admin group (e.g., bcs.admin). As a non-limiting example, for the top level, the member role Grouplings may be named as follows:
bcs_managers (very limited list)
bcs_editors (limited list)
bcs_participants (consider setting to bcs-all)
bcs_viewers (always equals bcs-all at this top level)

For the admin group, these role Grouplings may be named as follows:
bcs.admin_managers
bcs.admin_editors
bcs.admin_participants (typically empty)
bcs.admin_viewers (typically empty)

In the BCS example, the following additional Groupling configuration is suitable for establishing a sub-group within the BCS domain:
1. The sub-group owner (to become Manager by default) identifies the group members, selecting from the top level—all Groupling (e.g., bcs-all), and assigns the roles for the identified group members. New Grouplings are created to store the role assignments by appending the role (managers, editors, participants, viewers) with an underscore to the base group name. For example, the following Grouplings may be created for the group bcs.grades.first:
   a. bcs.grades.first_managers
   b. bcs.grades.first_editors
   c. bcs.grades.first_participants
   d. bcs.grades.first_viewers
2. The bcs.grades.first Groupling is added to the “Local Permissions” so that members of the bcs.grades.first group may be granted access (or additional access) over items in the corresponding folder and subfolders.
3. Using the union of the role Groupling assigned above to define the overall sub-group membership, member type Grouplings for this sub-group are automatically created, with names such as the following:
   bcs.grades.first—students
   bcs.grades.first—teachers
   a bcs.grades.first—admins
   bcs.grades.first—parents
   bcs.grades.first—others
   bcs.grades.first—all
4. Lastly, the standard objects and folders are automatically added (dashboard, members, content, archives, utilities, for example).

With respect to agent relationships, the act of establishing an agent with the ability to act on behalf of another user is not bi-directional, according to certain embodiments. For example, parents would like to act on behalf of their children, but not vice-versa. A pair of users can establish each other as agents in order to create a bi-directional agent relationship, such as in the case of spouses.

A family group is an example of a set of specialized group with specific agent relationships as described above. The online environment of certain embodiments provides for the creation of specialized groups with specific agent relationships and roles between the members of the group and custom treatment of views and actions within the online environment of certain embodiments based on the types of groups being supported. These specialized groups and their associated views can be adopted by users and groups, or created by the groups themselves.

Once an agent relationship is created, an agent may have access to all of the content, views, and actions available to the user that the agent is representing, and at least the following is applicable, according to certain embodiments:
Access to view all content, news, events, notices, and payment requests that apply to the user;
The capability to act upon event registration requests, payment requests, and any other group requests or obligations that apply to the user; and
The ability to request or confirm membership to a new group on behalf of the user.

An agent may or may not have access to the communication and collaboration tools (e.g., chat, forums, email) to communicate on behalf of the user, and may or may not have access to the user's configuration panel depending on the restrictions that are applied to the agent relationship, according to certain embodiments.

This online environment of certain embodiments also provides the following capabilities for supporting agent relationships:
The ability to create named or specialized agent relationships, such as parent, spouse, and family relationships, and to customize the roles, privileges, and website viewing capabilities based on these specialized relationships;
Personalized dashboard view modes based on all content applicable to a user and the user's agent roles, or all of the user's agent roles, or for a single agent role, including any content, news, events, notices, and payment requests applicable to that view mode;
Expanded group directory listing views that include agent relationships, either generically or in a specialized mode (e.g., listing parents as agents for a child in a school group);
The ability to customize treatment of payment requests and event registrations based on agent relationships or specialized groups (e.g., a family group) where a single payment or registration may apply to the entire group, or individually to each member of the group.

To track agent relationships, an agent Groupling may be assigned to each user. The agent Groupling is named according to the user's name agent.<username> and contains the user ids of the user's agents. For example, an agent Groupling for a child may look like:
agents.johnjr_smith with agents,
   john_sr_smith (father)
   sue_sr_smith (mother)

Email exploders associated with Grouplings are a powerful communication tool featured within the online environment of certain embodiments. Email exploders can be used to send email directly to a group of people, or more likely, to send email directly into a forum associated with the Groupling. There are two sample naming conventions for email exploders. The generic approach is based on appending the group name hierarchy to the service providers' domain. Some examples for BCS are:
first.grades.bcs@<service provider domain>.com
first.grades.bcs-students@<service provider domain>.com
first.grades.bcs_managers@<service provider domain>.com

The second email exploder naming convention is based on utilizing a custom web domain that a group has forwarded to their Group Domain within the service provider's web site. Returning to the above BCS example, if BCS owns the “bullischarterschool.net” web domain and enabled domain-forwarding to their Group Domain, the email exploders may look like:

1. first.grades@bullischarterschool.net

2. first.grades-students@bullischarterschool.net

3. first.grades_managers@bullischarterschool.net

Maintaining the security and integrity of the various Group Domains within an online environment of certain embodiments creates a trusted “walled garden” environment where private and sensitive organizational and personal information can be created and maintained. The online environment of certain embodiments provides an encrypted login capability along with encrypted data transfers after an Authenticated User logs into the online environment. The security of a user's identity is tied to a unique and valid email address, for example. Generally, an authenticated user has no access to Group Domains unless the user is granted membership to the Group Domain. Thus, managers of a Group Domain verify a user's identity and email address prior to granting the user membership privileges. With such a scheme, a user can reuse his identity for each additional Group Domain that the user joins.

Even though a user may belong to multiple Group Domains and groups, the user participates in each group separately, thereby preserving the integrity of each group's “walled garden”. The user can view and act upon content that is consolidated from various groups into the user's home dashboard. However, the user's role and access rights are automatically modified to the appropriate levels with respect to the content the user is viewing or upon which the user is acting depending on the group context associated with the content.

### User Customization and Personalization

Each user of the online environment or a service instance has his/her virtual home in the online environment, according to certain embodiments. The user's virtual home includes a dashboard, content folders and items, preference settings, profile settings, and other utilities such as payment status views and reporting. Each user's virtual home functions as the user's personal “walled garden” environment to which only the authenticated user has access, unless the user designates one or more agents with access rights to the user's virtual home. Whenever an authenticated user successfully logs into the service, the authenticated user is directed to that user's dashboard page. The home dashboard is the focal point with respect to the user's ability to view and act upon content items and requests. The dashboard consolidates such information from all groups in which the user is a member. The home dashboard is also the springboard to other Group Domains and favorite groups of the user.

Within the “preference” tool, a user can establish a personal profile and contact information. By default, this information is not available to Group Domains or groups unless specified by the user. The user can configure the profile information to allow portions of the profile information to be shared with a specified Group Domain. A non-limiting implementation includes a table with the rows comprising various pieces of personal information (address number, street address, city, state, zip, home phone, cell phone, fax number, email address, alternate email address, etc.). The columns may list the group domains to which the respective user belongs. Each cell (at the intersections of the rows & columns) may contain a checkbox that can be checked or unchecked by the respective user depending on whether the respective user wishes to disclose, to the specified Group Domain, the piece of information in the corresponding cell.

Many of the informational panes in the dashboard are configured to consolidate information from all the groups for which the user is a member. The user may customize this setting by de-selecting groups for inclusion in the dashboard in the “preferences” tool. Each group, for which the user is a member, has the same relative priority for the purpose of determining which content items are to appear in the dashboard. However, the user may also raise or lower the priority of each group or an entire Group Domain in the “preferences” tool. In other words, the user is provided a “volume” knob for each group. If the user turns a groups' “volume” down to zero, the group is effectively removed from the dashboard all-together without affecting the user's membership in the group. Such preference settings have an impact on the dashboard panes because the panes consolidate information from several groups.

An example of a user's home dashboard is shown in FIG. 8. Generally, each of the panes allows some amount of customization. The user may select panes and customize the composition of the selected panes for the user's dashboard. Many of the panes shown in the user dashboard view appear while the user navigates through the user and group folders and views. In other words, the user dashboard panes are specific to the user. As shown in FIG. 8, the panes that are available to the user include: “Quick-nav” bar 802, Search box 804, Payment Status pane 806, a user folder navigation pane 808, an Events List pane 810 and a hot items list 812. The “Quick-nav” bar 802 includes links to the user's Group Domains and favorite groups, for example. The links in the Quick-nav bar are customizable. According to certain embodiments, the default configuration is for all of the user's Group Domains to be present in the Quick-nav bar. Whenever a user joins a new Group Domain, the new Group Domain is added to the Quick-nav bar.

The payment status pane contains a summary of the user's payment requests, typically from all groups of which the user is a member except for groups for which the “volume” set to zero by the user. A summary of the number of open and pending payments, as well as the date of the next payment that is due, may be viewed at payment status pane. Each status text is also a functional link that takes the user to a more detailed payment status view, or to an individual payment request.

The search box allows the user to search for content within the user's home or within groups of which the user is a member. The default action for a search is to search for content within all groups and the user's home. However, the user has options to restrict the search to the user's home, to all groups, or to the current group to where the user has navigated (only applicable when the user is navigating or viewing content within a group home area).

The user folder navigation pane offers quick access to the user's content items, preferences, profile settings, dashboard page, utilities, list of the groups for which the user is a member, and payment request status page. Most of the applicable customizations and user preference settings are available from this location. The Content folder behaves in the same way as a group's content folder. The content folder is a location for a user to add content items, such as files, pictures, news items, and so on. A user may allow other users or even groups of users to access selected content items, but in so doing does not enable other users to gain access to the rest of a user's content items and home area. The “groups” list page: 1) displays all the groups for which the user is a member including those groups for which the “volume” is set to zero by the user, 2) includes links to each group, 3) allows the user to accept requests to join new groups, and 4) allows the user to cancel group memberships.

The events list pane includes an at-a-glance view of current upcoming events of the highest priority consolidated from all the groups of which the user is a member. Generally, each item in the list includes the event title, date(s), and group label to indicate the group with which the event is associated. The text for each event is an active HTML link, for example, to a page comprising the details of the event in the applicable group's home content area.

The largest pane in the dashboard generally includes the user's “hot items list.” The hot items list is a consolidated and prioritized summary list of content items from all the groups of which the user is a member. According to certain embodiments, each item in the list includes an icon indicating the type of content (e.g., news item, need item, event, payment request, picture, etc), an item title, the short description or overview of the item (if any), and a group label to indicate the group with which the item is associated. As a non-limiting example, the text and icons associated with each item is an active HTML link to a page containing a view of the content item with the associated details. By default the list is sorted and filtered based on a method described below. However, the user has many options for specifying the sort and/or filter criteria for the hot items list, including:
User's group priority setting
Content creation/modification date
Content valid, expire, visible, invisible and target dates
Content valid date
Content expire date
Content title

A method is used by the online environment of certain embodiments to determine the degree of visibility of various content items when displayed in a user's dashboard. In general, the method is used to determine a dashboard rank ordering score (or just “rank”), for example, from 0-10 for each content item applicable to a specific user: A list of content items is created in order of highest dashboard priority score to the lowest score. For instance, if there is space to display X number of content items in a dashboard pane, then the first X items from the prioritized list are displayed in rank order by the display software.

The method used in determining the dashboard priority score for a content item may be fixed, or adjustable by a service provider based on user feedback and based on the performance of the method. Thus, the choice of method may vary from implementation to implementation. However, an example of the dashboard rank ordering score computation is shown below.

In this example, the following components are used in the determining a content items' dashboard rank, according to certain embodiments:
Dashboardᵣₐₙₖ—computed dashboard rank (range: 0-10)
   Maxᵣₐₙₖ=10
Content_{priority}—priority of the content item set by the owner (range: 0-10, default: 5)
Notice_Designation—1 if the content item has been designated as a “notice,” otherwise 0
Group_Domain_{weight}—the user's weighting (or “volume”) setting for the Group Domain associated with this content item (range: 0-1.0, default: 0.5)
Group_{weight}—the user's weighting (or “volume”) setting for the specific group associated with this content item (range: 0-1.0, default: 0.5)
Date_{priority}—date-based priority of the content item computed using a separate method from the visible, invisible, and target dates (range: 0-1.0)

The dashboard priority score of a specific content item can be represented by:

```
If Notice_Designation
  Dashboardᵣₐₙₖ = Max_{priority} * Group_Domain_{priority} * Group_{priority} *
  Date_{priority}
else
  Dashboardᵣₐₙₖ = Content_{priority} * Group_Domain_{priority} * Group_{priority} *
  Date_{priority}
```

where all the components except Date_{priority} are set by either the user or established by the owner of the content item. The Date_{priority} component is computed in the following manner:

```
if Date_{today} <= Date_{target}
  Date_{priority} = 1 − (Date_{target} − Date_{today}) / (Date_{target} − Date_{visible})
else
  Date_{priority} = 1 − (Date_{today} − Date_{target}) / (Date_{invisible} − Date_{target})
```

### Managers and Coordinators

The Manager role is a special role within a group. In a use-scenario, the manager role is assumed by a group coordinator or lead person. Initially the Manager role defaults to the user that created the group. In many cases, a new group may be formed temporarily for the purpose of coordinating an event, a class, or a workshop, for example. In such a case, the Manager role may be assumed by the user who is leading the temporary event, such as a play or concert, or a teacher, or a volunteer group lead. A Group Manager may delegate a multitude of tasks such as the above and create a sub-group for coordination of the associated activities. The Manager role usually does not vary from one group to another, with two exceptions, according to certain embodiments. The Manager of a Top-level Group (a group with no parents) has expanded privileges in comparison to a Manager of any other group (that has a parent group). The second case in which a Manager's roles can vary from one group to another is based on the access roles and modified inheritance rules established by a manager of a group that is higher up in the group hierarchy. Managers can limit access roles, reduce inheritance capabilities, or force certain attributes to be inherited by sub-groups formed below their group in the hierarchy, according to certain embodiments. A top-level Group manager role is usually assumed by one or more group officers or administrators because such a role includes managing the Group Domain membership, identity, and access rules and privileges.

The typical permissions and roles available to a group manager are listed in TABLE 1. A manager may modify the group inheritance and permissions settings to limit or prohibit some of the Manager permissions available to groups that are lower in the group hierarchy. Some examples of limiting the permissions of a sub-group manage are discussed below.

A group may have one or more Administration sub-groups associated with it. The group Manager can delegate portions of the Manager role to other Manager or Editor roles within each sub-group. Such Administration sub-groups are simply special cases of a Group Manager's ability to create sub-groups and to delegate authority. Five sample roles in the Administration sub-group are listed in TABLE 4. TABLE 4 describes the manager roles for Accounting, Admissions, Support, Member and Merchant sub-groups.

TABLE 4

| Manager roles | | |
|---|---|---|
| for | | |
| administration | | |
| sub-groups | Access Rights For: | Availability |
| Accounting | Setting group bank account preferences and | Whenever a Payment |
| Manager | profiles | Service exists |
| | Setting up manual or automatic fund transfers | |
| | between a group account within the online | |
| | environment of certain embodiments and one | |
| | or more external group bank accounts | |
| | Setting inheritance rules for this group's | |
| | Payment Service - optional, compulsory, or | |
| | no access for sub-groups to this Payment | |
| | Service | |
| | Accepting requests for creating a new | |
| | Payment Request from other domain members | |
| | Accepting an online or offline reimbursement | |
| | request | |
| | Creating an online or offline reimbursement | |
| | Accepting or creating an online or offline | |
| | refund of a payment | |
| | Accessing all group fund transaction, member | |
| | payment transaction, and payment history | |
| | reports | |
| | Establishing options for agents and | |
| | Grouplings to apply for new Payment | |
| | Requests (e.g., one payment per family, per | |
| | person, etc.) | |
| Admissions | Determining which users of the online | Typically at the Group |
| Manager | environment of certain embodiments are | Domain level, or |
| | permitted access to the protected portion of | perhaps within limited |
| | the Group Domain, or to the portion of the | sub-groups of a large |
| | Group Domain that is covered by a certain | organization |
| | admissions management function | |
| | Making the list of Admitted Users available to | |
| | the member managers of all sub-groups falling | |
| | under this admissions management function in | |
| | the group tree, to determine which users may | |
| | be added as members of their groups | |
| | Providing means to import admitted user | |
| | information from other sources, such as .csv | |
| | files, LDAP directories, VCARD files, etc. | |
| | Providing means to export admitted user | |
| | information for the purposes of backing up, or | |
| | manipulation with external tools | |
| Support | Providing level 1 support for group managers | Typically at the Group |
| Manager | and Group Domain members. | Domain level, or |
| | Escalating unsolved level 2 support issues to | perhaps within limited |
| | the online service provider. | sub-groups of a large |
| | For individuals that qualify for admission (due | organization |
| | to community involvement, payment of | In certain use-scenarios, |
| | registration dues, or other reasons) but who | this role may also |
| | have not yet become an Authenticated User, | embody the Admissions |
| | providing online assistance in registering a | Manager role. |
| | username, password with the online | |
| | environment service, and help in entering | |
| | initial user profile information. | |
| Member | Determining the membership of this sub- | Always, according to |
| Manager | group (from among the admitted users within | certain embodiments |
| | this Group Domain, or this branch of the | |
| | Group Domain), | |
| | Determining the members roles for this group, | |
| | Establishing rules for which agent | |
| | relationships are used within the group, | |
| | Establishing and managing Grouplings and | |
| | associated email exploders, | |
| | Establishing sub-groups (thus, automatically | |
| | becoming a manager of the subgroup) and | |
| | determining the inheritance policies for each | |
| | of the attributes of this sub-group (in | |
| | particular, the attribute associated with role | |
| | inheritance), among the following choices: | |
| | Attribute may be overwritten | |
| | Attribute may not be overwritten in this | |
| | sub-group, but may be overwritten in this | |
| | subgroup's children sub-groups | |
| | Attribute may not be overwritten in this | |
| | sub-group, or any of its children sub- | |
| | groups, etc. (i.e., attribute is fixed | |
| | throughout this branch of the tree) | |
| Merchant | Accept or reject the inclusion of marketing | Typically at Group |
| Manager | and advertising from new merchants | Domain level only, but |
| | Suspend the inclusion of marketing and | at preference of Group |
| | advertising from existing merchants | Domain Manager |
| | Remove specific merchant advertisements | |
| | from being viewed within the Group Domain | |
| | or specific groups in the domain | |
| | Highlight or promote (as allowed by the | |
| | online environment of certain embodiments) | |
| | specific merchants or marketing and | |
| | advertising programs | |

However, other possibilities for delegating Manager tasks may exist. Thus, the roles that are supported in the online environment may vary from implementation to implementation. These roles are merely a collection of permissions and access surrounding accounting and member administration, and each can be handled directly by the manager(s) or assigned to another group member depending on the manager's preference. However, each role is discussed herein as a set of access rules and tools available to a Group manager.

A use-scenario for handling group accounting and payments includes assigning the Accounting Manager role to the Group Treasurer and to then disable the ability for other groups in the domain to create their own Payment Service. Thus, all payments and accounting issues are handled by the Group Treasurer. However, in larger and more complex group organizations, such as national organizations, it may be beneficial for sub-groups to have the ability to create and manage their own accounts.

In a top-level Group, an Admissions Management sub-group and one or more Admissions Manager roles may be established to manage admission of members into the Group Domain using an Admissions Management tool. In larger and more complex organizations, other Admissions Management sub-groups may be needed in other parts of the Group Domain hierarchy, as in the case of handling sub-group regional membership.

An important role of the Admissions Manager is authenticating and registering new users as members. The task of establishing or managing Group Domain membership may be handled in one or more of the following ways by an Admissions Manager and an Admissions Management tool, according to certain embodiments:
1. Using an existing group membership list including at least member names and email addresses, entering the list into a CSV file and importing them into the site, or entering the membership details manually, causing a membership invitation email to be sent to everyone on the list.
2. Creating a group membership or sign-up list by distributing a sign-up sheet at a group event and then entering the membership details into the site as in case 1.
3. Distributing the Group Domain URL to new or existing group members by email or hard-copy (e.g., flyer) allowing members to request a group membership within the online environment of certain embodiments. Ideally, the Admissions Manager has a way to confirm the validity of the requesting member's email address and can then grant membership.

The Support sub-group and Support Manager role is used to centralize support for the Group Domain, or associated Group Sub-Tree, to one or more group members. The Support sub-group and Support Manager are provided with support tools in the online environment. As a non-limiting example, the support tools provide level 1 support and include the ability to escalate unsolved issues to level 2 for sending to the online environment's support group. The online environment provides flexibility for the Support Manager role and enables associated responsibilities to be out-sourced to a third party at the preference of the Group Domain. For example, the online environment may offer level 1 support services to Group Domains at a fee.

A Member Management sub-group and Member Manager role is a light-weight mechanism used by a group to manage member administration, including the creation and management of Grouplings and their associated email exploders. Parent group memberships can be used automatically to limit group membership by a Member Manager, but the Group Domain member directory is automatically used by the online environment of certain embodiments to ensure that only Group Domain members are added as members of a group. Thus, any new members that are granted access to the group have been authenticated at the Group Domain level.

The term “Coordinator”, used within the online environment, refers to a person who creates either an Event or a Payment Request content item. The term “Coordinator” typically applies to a real-life group coordinator.

### Group Views, Forms and Customization

The group home dashboard is the starting point for viewing a summary of what's happening within a group. The group home dashboard has many panes in common with the user home dashboard. Additionally, when navigating anywhere within a Group Domain, the group identity is typically visible at the top of the window. The group logo or identity is usually configured at the Group Domain level and can be inherited or over-written within sub-groups depending on the inheritance rules created by the group managers.

As described in the User Home Dashboard, the following panes are also visible when the user views a group home dashboard (and in most other views within the online environment of certain embodiments: “Quick-nav” bar, Search, Payment Status pane, and the Events List pane. The functionality and content viewed in each of these panes behaves in a similar way as described in the User Home Dashboard section, with the exception of the Events List pane.

The content displayed in the Events List pane defaults to showing events associated with the current group and sub-groups rather than consolidating events from all the groups of which the user is a member. The user may customize the events viewed in the Events List to consolidate events from:
Current group only
Current group and sub-groups (default)
Current group, sub-groups, and parent groups (note that this is different than consolidating events from the entire Group Domain since the group hierarchy is traversed above and below the current group for consolidation which excludes groups not in the same tree as the current group)

When events from more than one group are shown in the Event List pane then the event associated with the current group are highlighted.

The Group folder navigation pane may contain links to the following items while the user navigates anywhere within a group home, according to certain embodiments:
Member directory—access to directories and communication with members
Group content folder—contains content items created by editors and managers
Administration folder and tools—for Managers and any members assigned to one or more administrative sub-groups, which may include:
   Payment Service—if one exists for the group
   Admissions tool—used by Managers only to configure Grouplings and other group configurations
   Support tools—used by Managers to support the group and members
   Accounting and transaction tools—used by Managers to track and report on payments and transactions
Sub-group folders—only sub-groups one layer down in the hierarchy are shown

From the Group folder navigation pane, a user can quickly navigate to the group home dashboard, sub-groups, group content folders, and member directory. From the Group folder navigation pane, a manager can gain access to group administration tools that they utilize in their role.

The following content items may have forms available for Editors to create content and views available for other members to view the content items:
News items
Need items
Events
Payment Requests
Polls
Votes
Forums
Files (pictures, videos, documents of any kind)

Each content item type has a specialized form and view mode, according to certain embodiments. TABLE 5 illustrates some non-limiting examples for form and view fields which are applicable or available for all content items.

TABLE 5

| Content Item | | | |
|---|---|---|---|
| Attribute | Type | Default | Description |
| ObjectID | | | Auto-generated unique ID for this object |
| OwnerID | agentID[ ] | | ID of the user who created this object |
| Name | Text | | Object Name |
| Summary | Text | | Summary Description |
| ValidDate | Date | | Date this object becomes relevant |
| EventDate | Date | | Date of the event and when this object |
| | | | becomes irrelevant |
| Access | | | Access rights to this object |
| Context | | | Folder context in which this object resides |
| VisibleDate | Date | ValidDate | When this object becomes visible in |
| | | | aggregated views |
| InvisibleDate | Date | ExpireDate | When this object is removed from |
| | | | aggregated views |
| TargetDate | Date | ExpireDate | When this object has maximum visibility in |
| | | | aggregated views |
| Notice | Boolean | Off | An on/off field enabling the content item to |
| | | | be tagged as a “Notice”, thereby increasing |
| | | | its priority and promoting it to dashboard |
| | | | views |
| Priority | Int | | Relative priority of this object, from 0 |
| | | | (lowest) to 10 (highest) |
| Involved | agentID[ ] | | List of IDs of the involved or affected |
| | | | groups and users |
| Description | XHTML | | Detailed description, with links, etc. |
| HeadlineImg | XHTML | | An optional link to a headline image |
| AllowDiscussion | Boolean | On | An on/off field enabling discussion on a |
| | | | content item |
| PaymentRqst | GpPymtRequest | | An optional link to a Payment Request item |
| NeedsRqst | GpNeedsRequest | | An optional link to a Needs Request list |

Content items in the online environment of certain embodiments include Event, Needs, and Payment Request content items. Some non-limiting examples for form and view fields associated with an Event are listed in TABLE 6.

TABLE 6

| Additional Event | | | |
|---|---|---|---|
| Attributes | Type | Default | Description |
| Location | Text[ ] | | Brief location name |
| Recurrence | Boolean | Off | An on/off field enabling the |
| | | | following additional fields (all view |
| | | | instances of this event in a calendar |
| | | | would link back to the same event |
| | | | view summary [e.g., there is only |
| | | | one event with a number of |
| | | | instances]) |
| Frequency | Selection | | Frequency of the recurrence: daily, |
| | | | weekly, bi-weekly, monthly, |
| | | | annually |
| Days | DayStr[ ] | | Specifies days of the week the event |
| | | | occurs on |
| StartDate | Date | | Start date of the recurrence |
| EndDate | Date | | End date of the recurrence |
| Registration | Boolean | Off | An on/off field specifying whether |
| | | | registration is used and enabling the |
| | | | following additional fields: |
| Compulsion | Selection | Requested | One of: Mandatory, Requested, or |
| | | | Elective |
| FinalDate | Date | EventDate | Final date for registration to occur |
| RegistrantType | Selection | Individual | One of: Individual, Group, Family |
| MaxRegistrants | Int | 0 | Maximum number of registrants |
| | | | allowed (zero indicates no limit) |
| NumRegistrants | Int | | Current number of registrants |
| NeedsRqst | GpNeedsRequest | | An optional pointer to associated |
| | | | Needs Request items |
| InviteEmail | Boolean | No | A yes/no field indicating whether an |
| | | | invitation email should be sent to |
| | | | invitees |
| EmailReminders | Boolean | Off | An on/off field enabling the |
| | | | following additional fields |
| | | | pertaining to email reminders being |
| | | | sent to invitees |
| ReminderDates | Date[ ] | | A list of dates upon which an email |
| | | | reminder should be sent to all |
| | | | invitees who have not specifically |
| | | | declined the invitation (the email |
| | | | reminder will contain the invitees |
| | | | current registration status) |

In the fields associated with Events, it possible to request or require registration for an event. Group members can register for an Event using simple Event Registration form fields incorporated into an Event form. Some non-limiting examples of fields associated with an Event Registration are listed in TABLE 7.

TABLE 7

| Event | | | |
|---|---|---|---|
| Registration | | | |
| Attributes | Type | Default | Description |
| ObjectID | | | Auto-generated unique ID for |
| | | | this object |
| RegistrantID | agentID[ ] | | ID of the user registering |
| Status | Selection | | One of: accept or decline |
| NumRegisterees | Int | | Number of registerees associated |
| | | | with the Registrant Type field in |
| | | | the Event form field (e.g., the |
| | | | number of individual |
| | | | participants or families |
| | | | depending on Registrant Type |
| | | | field) |
| Notes | Text | | Brief text from the responder to |
| | | | the coordinator |

“Needs” content items are a useful and flexible part of the online environment of certain embodiments. The ability to request a “need” within a group occurs in many different scenarios, including requesting volunteers to play specific roles at an event, to bring certain materials or foods, to be drivers or car-pool leads, etc. Other scenarios include requests for participation or donations. The online environment of certain embodiments supports an organization's requirements for coordinating “Needs” requests in a number of ways, including:
Posting a Needs content item in a stand-alone manner (similar to a news or event item) with associated fields and attributes.
A group Member responding to a “Needs” request by using a free-form “notes” or “memo” text field in a Payment Request Entry or an Event Request Entry.
A group Member responding to a “Needs” request by informally adding a note to the “Comments” section or forum associated with a Needs content item.
Using one or a list of Needs Request content item list to request a list of needs and track group member's responses to the requested needs in a more formal way.

A Needs Request item list is an advanced and detailed way for a group coordinator to request and track the response to needs. A Needs Request item list can be associated with or referenced by most other content items, but are particularly applicable to Event and Payment Request items where volunteers or items are being requested in association with an event. Some non-limiting examples of fields associated with a Needs Request item list are listed in TABLE 8.

TABLE 8

| Additional | | | |
|---|---|---|---|
| Needs | | | |
| Request | | | |
| Attributes | Type | Default | Description |
| Persistence | Selection | One-time | One of: One-time or Persistent (this is not like a |
| | | | persistent event, with recurrence parameters. When |
| | | | a persistent Need Request becomes |
| | | | closed/confirmed, an equivalent new request is |
| | | | simply automatically created (though with an initial |
| | | | status of “re-opened”). |
| NeedCount | Int | 1 | Number of different items being requested |
| NeedItems[ ] | Text[ ] | | Brief text describing items being requested (this |
| | | | array permits use of a drop-down list to request |
| | | | closely related items, and present them together). |
| Max qty[ ] | Int[ ] | {1, 1, 1 . . . } | Corresponding maximum quantity for each item. |
| NeedNote[ ] | Text[ ] | | Misc. requested information (shirt sizes, etc.) |
| ResponderId[ ] | agentID[ ] | | ID of the person responding or volunteering for this |
| | | | Need item |
| ResponderNote | Text[ ] | | Brief text from the responder to the coordinator |

Nearly all content items can be designated as a “Notice”, which is a special priority designation enabling an Editor to promote a content item to a group or user's dashboard view. This is particularly useful for important or time critical items needing to be highlighted to a group's membership. Whether an item with the Notice designation gets promoted to a group or user's dashboard depends on how many other content items of an equal or higher priority and with an imminent target date are applicable to the group or user dashboard.

Online payment forms and views are an important part of the online environment of certain embodiments and a key utility utilized by groups. This section only describes Online Payment actions forms, views, whereas the details of the online payment method are described in the “Online Payments and Tracking” section. The following usage cases and actions exist for the various roles within the online environment of certain embodiments:

Members:
Can view a summary of all payment requests or details of individual requests, including requests that are in various states of open, started, pending, failed, and completed.
Can select one of more open payment requests to initiate an online payment or offline payment.
Can choose to proceed with an online payment by a variety of methods, such as eCheck, bank or PayPal fund transfer, or credit card payment.
Can choose to proceed with an offline (cash or check) payment and enter the applicable information (check number) and notes.
Can choose to pass on a payment offer.
Can choose to accept and confirm a free (no payment required) offer.
Can choose to re-open a payment request which has previously been passed or paid by check or cash by the user (typically to correct some payment information).
Request an online or offline payment refund.

### Group Domain Manager or Accounting Manager:

Approve the creation of a Payment Request (if required).
Create or approve and execute an online reimbursement.
Create or approve an offline (cash or check) reimbursement.
Create or approve an online or offline refund of a payment.
Transfer funds between the various group transaction and bank accounts (explained in more detail later in this document).
Create, view, and save/export reports and history of transactions and accounts.
Specify the format to be used for the transaction reports such that the data in the reports can be exported to 3^{rd} party accounting software, for example.

### Coordinator or Members with at Least Group Editor Role:

Create or request approval for a Payment Request and select a number of members or groups of members to which the request applies.
Initiate or request an online or offline payment refund.
Request an online or offline reimbursement.
Create, view, and save report summaries for payment requests for which they are the owner.
Specify the format to be used for the payment request reports.

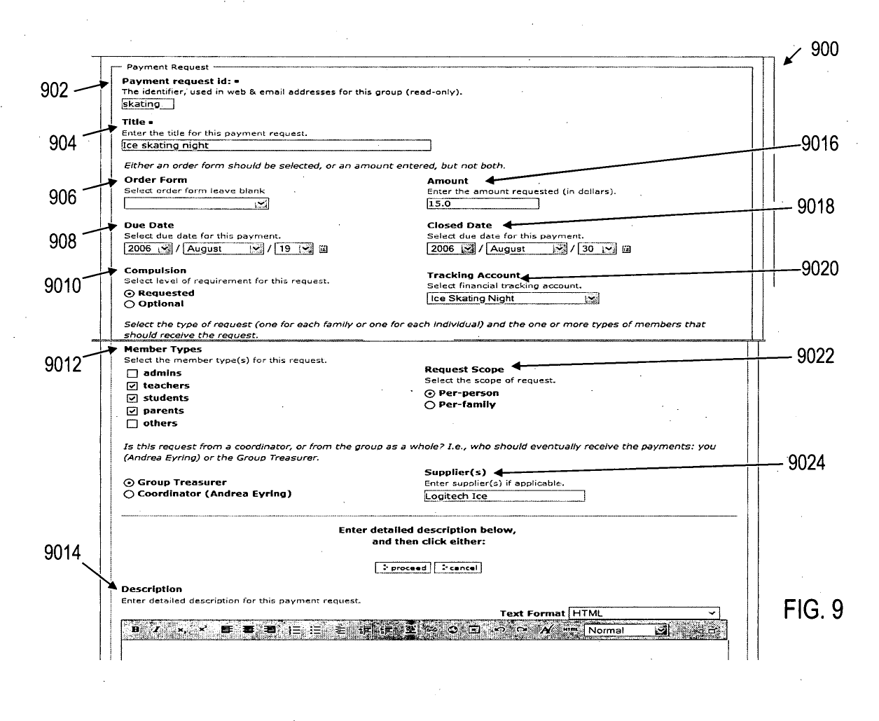

The forms and views associated with payments are listed in TABLE 9. An example of a Payment Request form that can be used by a coordinator to create a Payment Request is illustrated in FIG. 9, according to certain embodiments. FIG. 9 shows a payment request form 900. According to certain embodiments, payment request form 900 includes a payment request id 902, a title 904 for the payment request, order form selection 906, due date 908, a level of requirement 9010, member types 9012, a description 9014 for the payment request, an amount 9016 that is requested, a close date 9018, a tracking account 9020, a request scope 9022, and a suppliers indicator 9024.

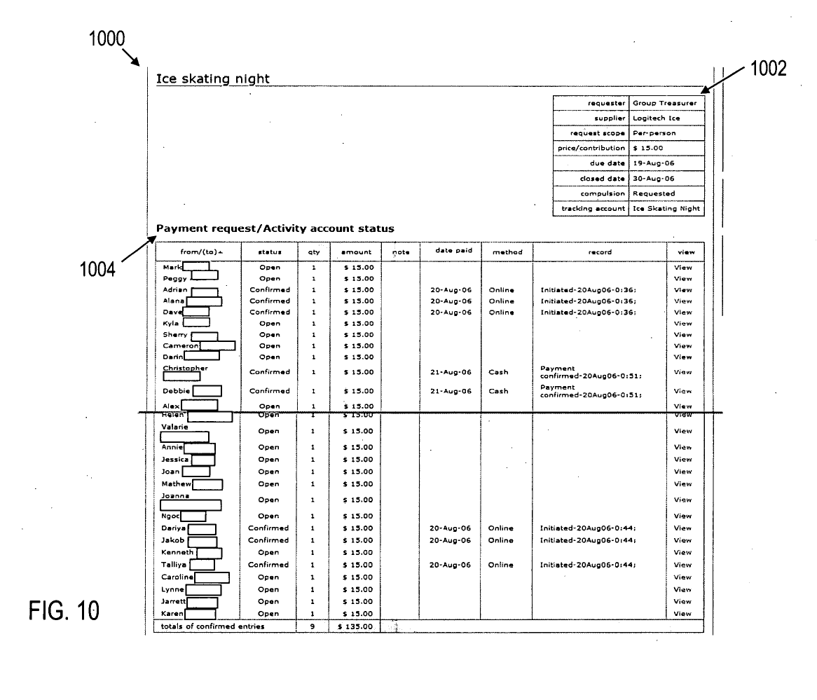

FIG. 10 shows a sample Payment Request Summary View 1000, according to certain embodiments. Request Summary View 1000 shows a summary description pane 1002 and a payment request/activity account status pane 1004. The payment request/activity account status pane 1004 shows certain details such as the identity of members from whom payment is requested, the status of the payments, the amount of payment requested from the respective members, date of payment, method of payment, etc.

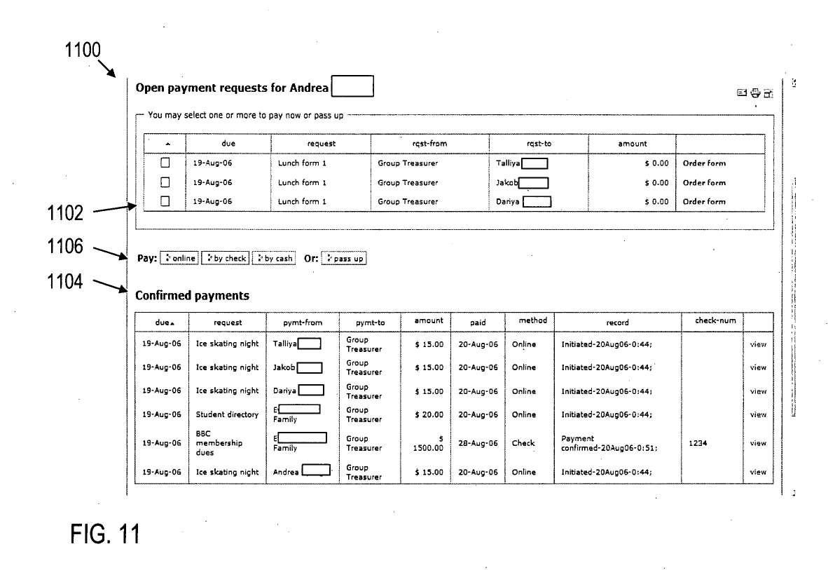

FIG. 11 shows a sample Payment Request Summary View 1100 for an individual and/or family, according to certain embodiments. Payment Request Summary View 1100 includes an open payment requests pane 1102, a confirmed payments pane 1104 and a payment type selection 1106. The Payments Request summary view may optionally contain a list of passed and closed payment requests as well.

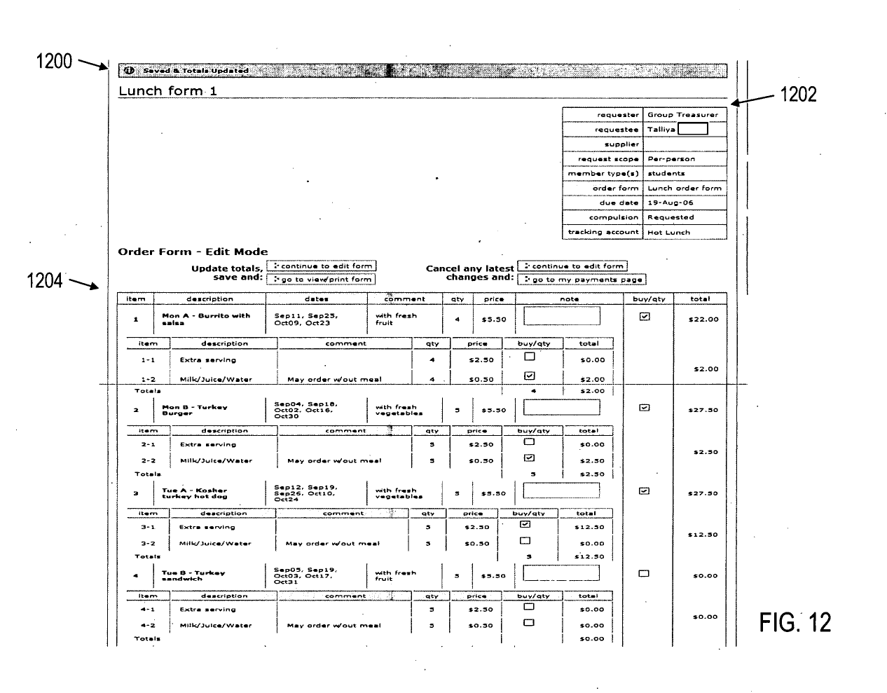

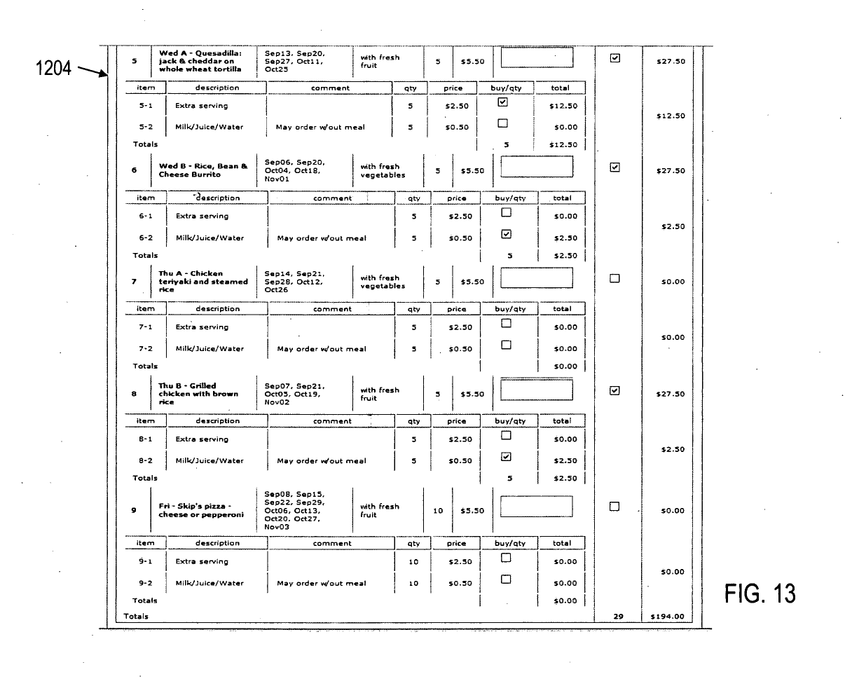

FIG. 12 and FIG. 13 show a sample order form 1200 that is associated with a payment request, according to certain embodiments. Sample order form 1200 includes a summary description pane 1202, and an item selection pane 1204. The item selection pane 1204 is continued on FIG. 13.

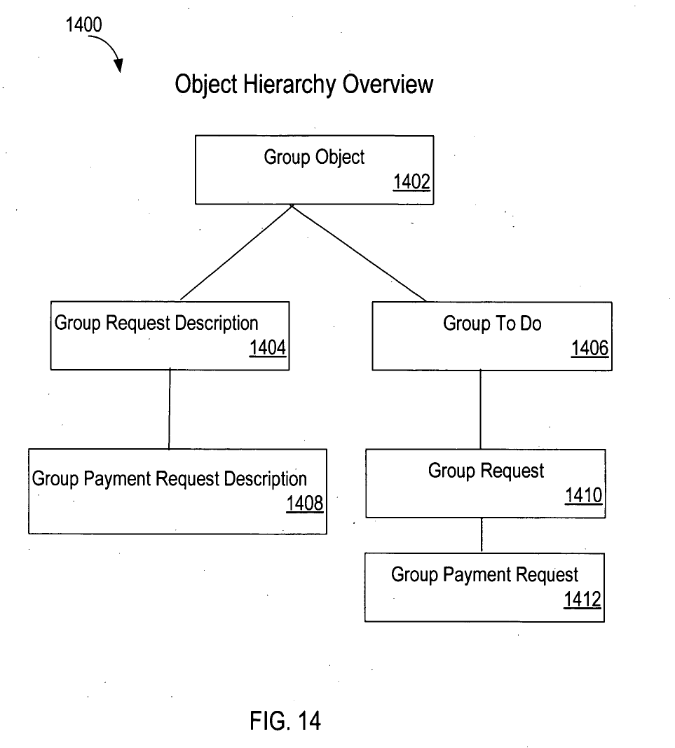

Depending on the need for Payment Request approvals (as defined by the Accounting Manager), when a coordinator submits a Payment Request, the payment request either will be submitted for approval to the Accounting Manager and subsequently be made available to group members, or the request will be made directly available to group members without an approval cycle. FIG. 14 illustrates the object hierarchy associated with online payments, according to certain embodiments. FIG. 14 shows an object hierarchy overview 1400 that includes a group object 1402. Group object 1402 can include a group request description 1404, and a group-to-do 1406. Group request description 1404 may include a group payment request description 1408. Group-to-do 1406 may include a group request 1410. Group request 1410 may include a group payment request 1412.

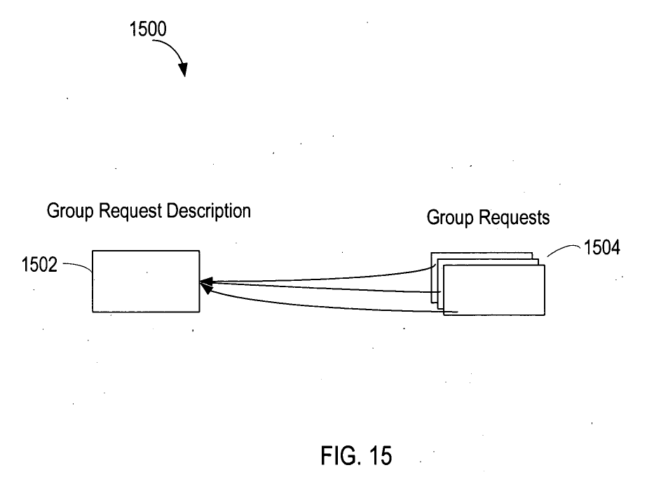

FIG. 15 illustrates details of the Group Request Object 1500, according to certain embodiments. FIG. 15 shows that the group request description 1502 is based on information obtained from a plurality of group requests 1504.

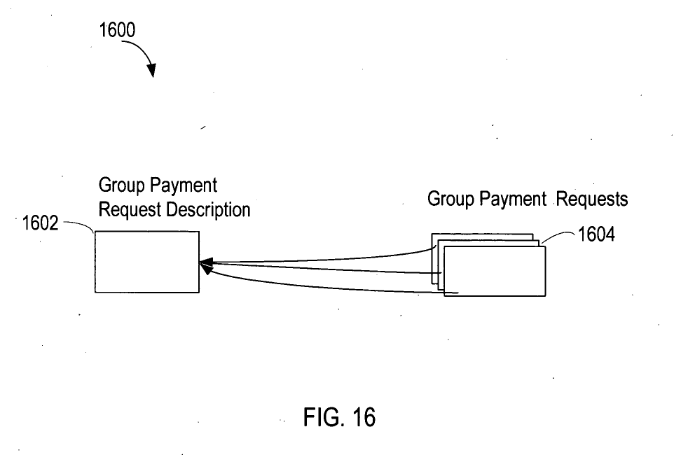

FIG. 16 illustrates details of the Group Payment Request Object 1600, according to certain embodiments. FIG. 16 shows that the group payment request description 1602 is based on information obtained from a plurality of group payment requests 1604.

Table 9 describes some sample payment views and request forms.

TABLE 9

| | |
|---|---|
| Accounting | The accounting manager's aggregated view that shows the payment status of all |
| Manager | payment requests. This view may also include a “Transfer to General Funds” button to |
| Payments View | initiate a transfer of money destined for the group's general funds into the group's |
| | bank account, and both “Online Reimbursement” and “Cash/Check Reimbursement” |
| | buttons to perform either an online or cash/check reimbursement to a coordinator. The |
| | accounting manager confirms the receipt of offline (cash/check) payments in this view |
| | and can view a summary of revenues for each payment request that has been created. |
| | Associated with this view is a reporting capability where criteria for transaction reports |
| | can be selected and the associated reports can be created and saved. The criteria for |
| | transaction reports include the format to be used for the report (used for importing data |
| | to 3^{rd} party accounting software). |
| Coordinator | The coordinator's aggregated view of the set of payment requests for a particular |
| Payments View | offering, showing who has and has not paid for this payment request. This view |
| | includes a “Cash/Check Refund” and “Online Refund” buttons to initiate a refund of a |
| | payment made by a member. Associated with this view is a reporting capability where |
| | criteria for summary reports can be selected and the associated reports can be created |
| | and saved. |
| Coordinator | The form used by a coordinator to establish one or more payment requests. Typically, |
| Payment | this form results in the generation of a set of payment requests, one for each member |
| Request Form | of a target group to this coordinator, or to the group's general fund. |
| Member | The member's aggregated view that shows that member's list of payment requests, |
| Payments View | identifying which payments are due and which have already been paid. Upon clicking |
| | “Pay Now,” a follow-up page includes a “Cash/Check Payment” and “Online |
| | Payment” buttons to initiate payment for one or more offerings. |

### Online Payments and Tracking

The online environment of certain embodiments provides a powerful set of tools for groups to efficiently handle online payments, reimbursements, refunds, and reporting of the associated transactions as previously discussed. The supporting online payment infrastructure and mechanisms used by groups to facilitate the online payments capability is described in this section.

For convenience of explanation, the following terms are used for online payments and tracking:
Payment Service—an entity created and used by a group or collection of groups in a single Group Domain to execute and manage online payments, comprising a payment gateway and associated transaction and group bank accounts.
Payment Service API—an interface description, design and implementation encapsulating the details for processing online payments regardless of the underlying payment mechanism or vendor.
Payment Gateway—an electronic payment transaction and clearing capability provided by a third party vendor and used by a service provider to facilitate online payments.
External Payment Service—a third party Payment Service including a bank account (and associated services) and a Payment Gateway which is used by groups to help facilitate online payments and is supported by the online environment of certain embodiments.
Virtual Transaction Account—a virtual group account within the online environment of certain embodiments which is used by the group to receive online payments and potentially process reimbursements and refunds.
Group Bank Account—a bank account managed and controlled by a group and typically linked to a Virtual Transaction Account or an External Payment Service.
Member Bank Account—a personal bank account managed and controlled by a member of a group.

Some of the software design details associated with online payments including object hierarchy, object descriptions, fields, and attributes are shown in TABLE 10 and TABLE 11, according to certain embodiments.

TABLE 10

| Attribute | Type | Default | Description |
|---|---|---|---|
| ObjectID | | | Auto-generated unique ID for this object |
| OwnerID | agentID[ ] | | ID of the user who created this object |
| Name | Text | | Object Name |
| Summary | Text | | Summary Description |
| ValidDate | Date | | Date this object becomes relevant |
| ExpireDate | Date | | Date this object becomes irrelevant |
| Access | | | Access rights to this object |
| Context | | | Folder context in which this object resides |
| VisibleDate | Date | ValidDate | When this object becomes visible in aggregated views |
| InvisibleDate | Date | ExpireDate | When this object is removed from aggregated views |
| TargetDate | Date | ExpireDate | When this object has maximum visibility in aggregated |
| | | | views |
| Priority | Int | | Relative priority of this object, from 0 (lowest) to 10 |
| | | | (highest) |
| Involved | agentID[ ] | | List of IDs of the involved or affected groups and users |
| Description | XHTML | | Detailed description, with links, etc. |
| Compulsion | Selection | Requested | One of: Mandatory, Requested, or Elective |
| Persistence | Selection | One-time | One of: One-time or Persistent. This is not like a |
| | | | persistent event, with recurrence parameters. When a |
| | | | persistent payment request becomes closed/confirmed, |
| | | | an equivalent new request is simply automatically |
| | | | created (though with an initial status of “re-opened”) |
| ItemCount | Int | 1 | Number of different items being offered |
| Item[ ] | Text[ ] | | Brief text describing items being offered. This array |
| | | | permits use of a drop-down list to purchase closely |
| | | | related items, and present them together. For |
| | | | example, such a list might be used for different color |
| | | | turtleneck shirts for different actors in a school play |
| | | | (e.g., blue for boys and yellow for girls). For more |
| | | | complicated mixes of products, multiple Payment |
| | | | Request Descriptions should be used |
| Amount[ ] | Float[ ] | | Corresponding prices for each item |
| Max qty[ ] | Int[ ] | {1, 1, 1 . . . } | Corresponding maximum quantity for each item. |
| ItemNote[ ] | Text[ ] | | Requested ordering information (shirt sizes, etc.) |

TABLE 11

| Attribute | Type | Default | Description |
|---|---|---|---|
| ObjectID | | | Auto-generated unique ID for this object |
| OwnerID | agentID[ ] | | ID of the user who created this object |
| Name | Text | | Object Name |
| Summary | Text | | Summary Description |
| ValidDate | Date | | Date this object becomes relevant |
| ExpireDate | Date | | Date this object becomes irrelevant |
| Access | | | Access rights to this object. |
| Context | | | Folder context in which this object resides. |
| VisibleDate | Date | ValidDate | When this object becomes visible in |
| | | | aggregated views |
| InvisibleDate | Date | ExpireDate | When this object is removed from |
| | | | aggregated views |
| TargetDate | Date | ExpireDate | When this object has maximum visibility in |
| | | | aggregated views |
| Priority | Int | | Relative priority of this object, from 0 |
| | | | (lowest) to 10 (highest) |
| Involved | agentID[ ] | | List of IDs of the involved or affected |
| | | | groups and users |
| Description | XHTML | | Detailed description, with links, etc. |
| Status | Selection | Open | One of: Open, Re-opened, Pending, Closed |
| ReminderDates | Date[ ] | | List of dates for transmitting reminder |
| | | | message(s). The method(s) and address(es) |
| | | | for sending alerts will be specified in each |
| | | | user's profile, to include email and SMS. |
| ReqDescription | | | ObjectID of the corresponding request |
| ID | | | description |
| RequesteeID | agentID | | ID of the member for whom this request is |
| | | | intended |
| Order[ ] | Int[ ] | {0, 0, 0 . . . } | The quantity of each |
| | | | GpPaymentDescription: Item[ ] ordered |
| OrderNote[ ] | Text[ ] | | Any additional ordering specifications (e.g., |
| | | | shirt sizes) |
| PymtAmount | Float | 0 | Total amount paid. If less than the requested |
| | | | amount is paid, then upon confirmation, a |
| | | | new payment request is created for the |
| | | | remaining amount |
| PymtDate | Date | | Date that payment was made |
| PymtClearing | Date | | The date that the payment cleared (typically |
| Date | | | the same as PymtDate for online payments, |
| | | | but can be delayed due to credit card or |
| | | | check clearing delays). Set based on IPN |
| | | | receipt date. |
| PymtMethod | Selection | | One of: Online PayPal, check, cash, ... |
| | | | (maybe others) |
| PymtRecordNum | Int | | Numeric record, such as the check no. or |
| | | | online transfer num. |
| PymtRecordText | Text | | Free text field to record any additional |
| | | | information re: payment |

The Payment Service API is used as an encapsulation method to allow the upper layers of software within the online environment of certain embodiments to be isolated from the details and various payment mechanisms used below the API in order to process online payments. Such an API enables flexibility to adopt, integrate, and support various third party Payment Gateway methods or External Payment Services. Notwithstanding the examples of third party implementations discussed in this document, it is envisioned that multiple other mechanisms will be supported in the embodiments. Some non-limiting examples of Payment Service API calls are listed in TABLE 12.

TABLE 12

Status paymentMake (transID, groupID, payer, amount)
(*paymentNotify) (transID, Status)
Status refundPerform (transID, groupID, refundeeID, amount)
Status reimbursementMake (transID, groupID, reimburseeID,
amount)
Status return info:
transID: payment transaction ID
paymentStatus: pending, authorized, unauthorized,
completed, failed

The functions of the Payment Service API include:
Making a payment—the payment may be completed (nearly) instantaneously or with a lengthy delay (seconds, hours or days).
Processing a payment status notification—the processing involves receipt of an asynchronous message or notification from a Payment Gateway or External Payment Service.
Refunds—refunds are initiated when a member requests a refund (and perhaps approved by an Accounting Manager). Refunds may be instantaneous or with a delay and asynchronous notification.
Reimbursements—reimbursements involve a transfer of funds from the group's Virtual Transaction Account or Group Bank Account to a Member Bank Account. Reimbursements may be instantaneous or with a delay and asynchronous notification.
Transfer of funds—this involves a transfer of funds between a group's Virtual Transaction Account and a Group Bank Account.

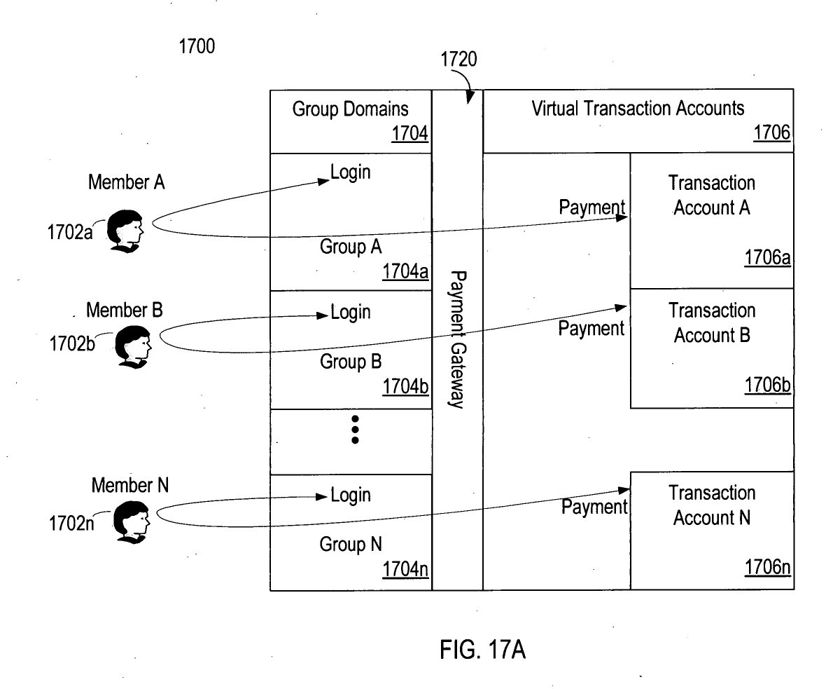

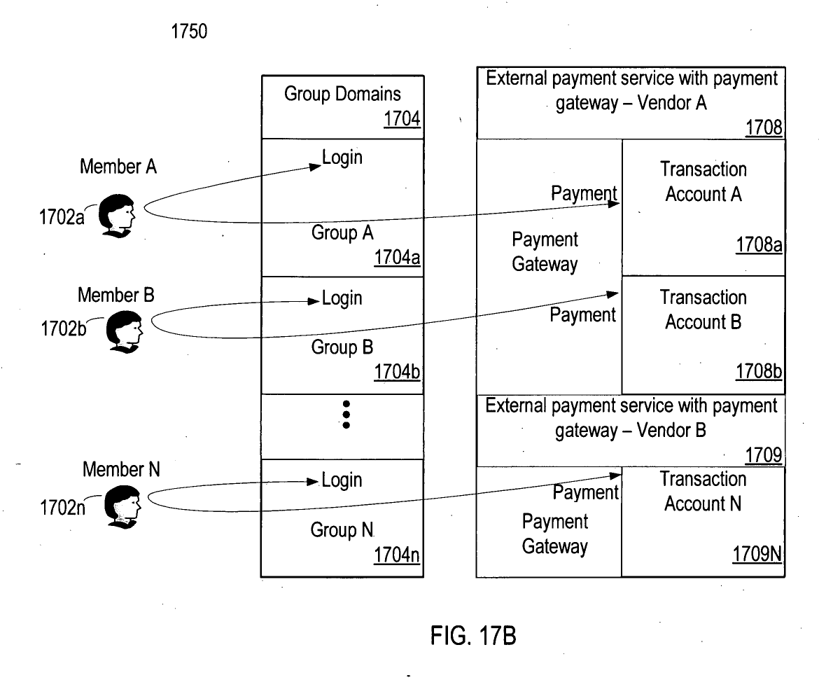

Two underlying methods for implementing online payments within the online environment of certain embodiments are described herein as non-limiting examples. The first involves the usage of an External Payment Service such as PayPal as a vendor that acts as a Payment Gateway and a Group Bank Account (see FIG. 17B). The second method involves utilizing a Payment Gateway and Service Provider merchant bank account as a Virtual Transaction Account for groups that are supported by the service (see FIG. 17A). In the first case of using an External Payment Service, the Group creates and maintains an account with the third party that is used for receiving online payments. In such a scenario, the online environment of certain embodiments may interface with the External Payment Service directly by integrating the Payment Service into the service provider's service instance. Thus, the entire payment procedure occurs within the online environment of certain embodiments. As an alternative, the online environment of certain embodiments can redirect the user to the External Payment Service website where the user completes a transaction, whether it is making a payment, transferring funds, or checking balances.

A group's Administrator or Accounting Manager can create an account with the External Payment Service vendor and then link the account to the online environment of certain embodiments within the Accounting Management tool, thereby enabling the online environment of certain embodiments to enact the Payment Service using the group-controlled account. One or more separate Group Bank Account's can be linked to the Payment Service bank account in order to transfer funds to a group's General Funds for example. The online environment of certain embodiments may provide for automation and tracking of the fund transfers, but the transfers themselves are carried out within the External Payment Service vendor's website in this scenario, for example.

The second Payment Service scenario or mechanism involves the integration of a Payment Gateway into the online environment of certain embodiments and the use of a Service Provider-controlled merchant bank account as the Virtual Transaction Account for the groups that are supported. FIG. 17A illustrates the relationship 1700 of the various accounts used in processing a payment in a payment service scenario. In such a scenario, the online environment of certain embodiments utilizes a Service Provider-managed merchant bank account to implement a number of Virtual Transaction Accounts 1706 for the group domains 1704 that are supported by the online environment. Group domains 1704 include a plurality of groups such as groups 1704a, 1704b, . . . , 1704n. Members corresponding to the group domains are members 1702a, 1702b, . . . , 1702n. Virtual Transaction Accounts 1706 include a plurality of transaction accounts such as accounts 1706a, 1706b, . . . , 1706n. The online environment of certain embodiments provides account management services as described earlier in this document for a group's Virtual Transaction Account and uses a Payment Gateway 1720 (integrated into the online environment of certain embodiments software) to enable member and group transactions to occur within the online environment website. One or more separate Group Bank Accounts can be linked to a group's Virtual Transaction Account via the Accounting Manager tool in order to transfer funds in and out of a group's General Funds, for example. In such a scenario, all payment, refund, reimbursement, and transfer actions would take place within the online environment website, and thus can be tracked for reporting purposes. FIG. 17B illustrates a scenario 1750 where one or more Payment Service vendors with payment gateway capabilities are used to process user payments, according to certain embodiments. FIG. 17B is similar to FIG. 17A. However, FIG. 17B shows the use of external payment services such as Vendor A 1708 and Vendor B 1709. Such external payment services have payment gateway capabilities. Transaction accounts 1708a, 1708b, and 1709N are associated members 1702a, 1702b and 1702n, respectively.

Depending on the scenario used and the kinds of merchant bank services that are provided by an External Payment Service or the Service Provider's merchant bank vendor, online reimbursements sent directly into a member's bank account may or may not be possible. In some cases, the member may be required to have a bank account with the External Payment Service vendor in order to handle reimbursements, such as with PayPal. However, in most cases the offline reimbursement method is available and provides for tracking and reporting of reimbursements.

### Merchants, Marketing and Rewards Programs

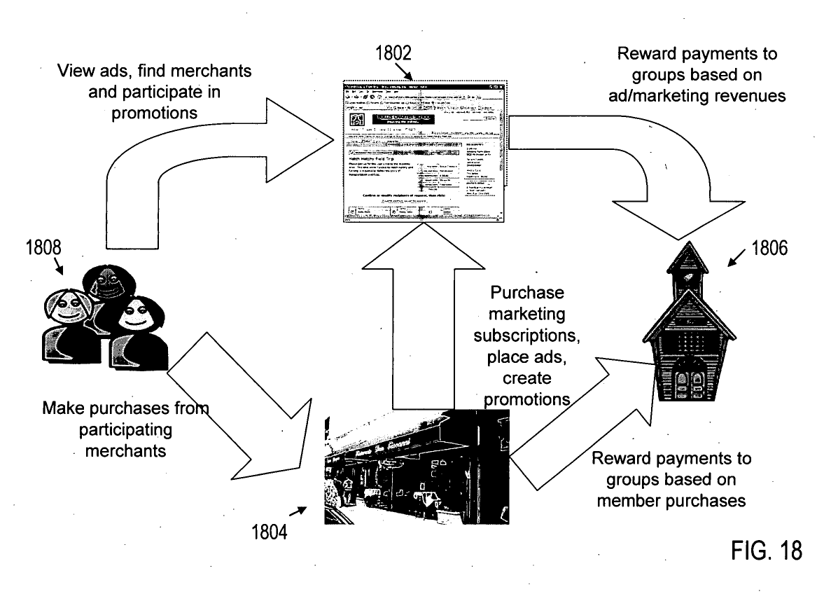

The online environment of certain embodiments include marketing and advertising programs being sold to merchant businesses, and reward programs for organizations participating as a Group Domain in the online environment. “GoLocal” is the term used to describe the marketing and advertising programs for merchant businesses. GroupReward is the term used to describe the revenue sharing and reward programs for groups. Together, the “GoLocal” and GroupReward features create a linkage and a win-win environment between a community's merchants and its schools, clubs and groups. The online environment of certain embodiments offers merchant businesses a dynamic and cost-effective way to market and promote themselves to Group Domains within the online environment. Such promotions can be targeted toward specific communities or geographies. An illustration of the GoLocal and GroupReward features is shown in FIG. 18.

FIG. 18 shows a group domain 1802, groups and local community organizations 1806, participating merchants 1804, and group members 1808. The GroupReward feature allows organizations 1806 that have created a Group Domain 1802 within the online environment of certain embodiments to receive reward payments from the online environment service provider based on: 1) the group members 1808 viewing merchant advertisements, 2) the group members 1808 participating in marketing promotions, and 3) the group members 1808 purchasing from participating merchant businesses 1804. The result is a pre-qualified, local and very motivated audience that provide merchants a strong return on their marketing investment. Additionally, the online environment of certain embodiments provides for direct rewards from merchants to groups based on the group member purchases.

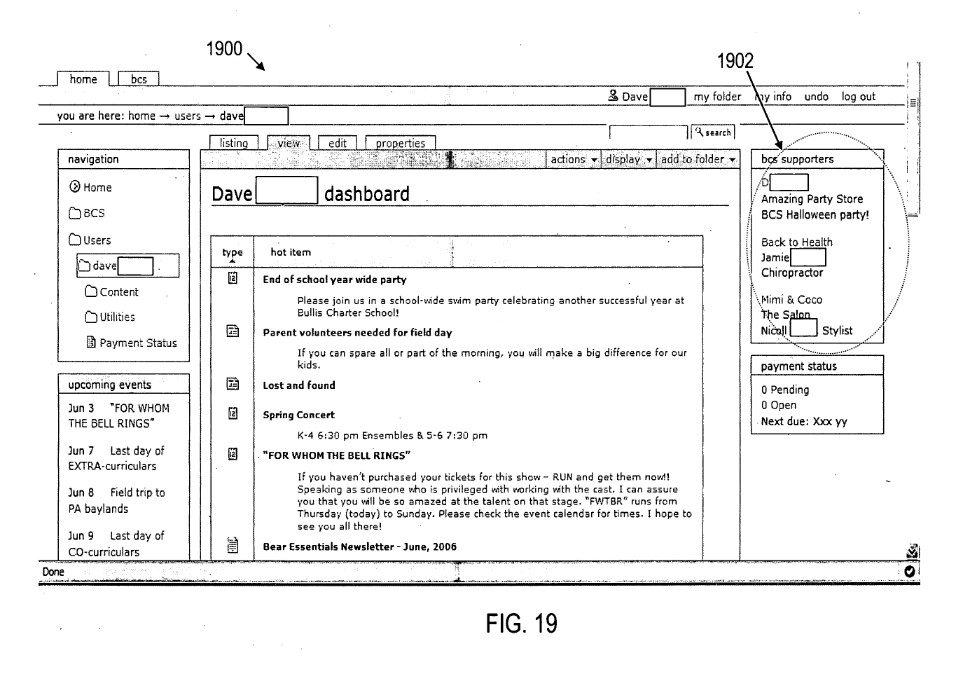

The online environment of certain embodiments provides a mechanism for merchants to create and place advertising and marketing snippets that can appear within the “Supporting Merchants Ad” pane which is displayed, in most cases, to a member when the member is browsing in the online environment website. FIG. 19 shows the “Supporting Merchants Ad” pane 1902, according to certain embodiments. Supporting Merchants Ad pane 1902 may include advertising and marketing information and quick links.

The online environment of certain embodiments tracks the frequency that members of a specific Group Domain view and click on advertisements, and bases the GroupReward payments to groups within a Group Domain on the members' participation levels. More detailed information about merchants and their GroupReward marketing programs can also be offered within the online environment website, such as:
An overview of the merchant business, its typical products, location, and contact information
GroupReward percentages for each merchant business for qualified purchases made by Group Domain members
Lists and maps of all participating merchants within x miles of a users' home
Filtered lists and maps of participating merchants (e.g., restaurants, cafés, clothing stores, grocery stores, automotive services, etc)
Specific marketing or promotional programs per merchant and GroupReward benefits for participation

The top-level group Manager within a Group Domain, or members with access to a Merchant Management administrative sub-group can determine which merchants and advertisements can reach their membership. The online environment of certain embodiments enables groups to filter and approve or reject advertising and marketing programs from new or existing merchant businesses. The ability to prevent inappropriate merchant advertising from reaching their membership may be a critical issue for certain types of organizations, particularly schools and other educational organization. Groups also have the ability to feature or highlight certain merchant businesses or marketing programs from a participating merchant to their group membership. Since the group itself collects GroupReward revenues based on the participation of their membership in advertising or marketing programs, the GroupReward feature facilitates a win-win-win relationship between a group, its members, and merchant businesses.

The online environment of certain embodiments allows for very flexible reward levels and relationships to exist between the service provider, merchant businesses, and groups. However, the revenue flow is generally from merchant business to the service provider in the form of advertising and/or marketing program subscription payments, followed by some portion of the revenues flowing to groups in the form of GroupReward payments based on their participation levels.

The GroupReward card or GroupReward tracking feature is used to track a user's purchasing activities at participating merchant businesses. In one scenario, GroupReward tracking is possible using a user's existing payment cards such as, credit, ATM, and/or loyalty cards, by registering them with the service provider. When these user cards are registered and used to make payments at participating Merchant Businesses by swiping the card at a Point-of-Sale terminal, they are used by the online environment to track a user's purchasing behavior and the applicable GroupReward revenues to be allocated to the groups in which the user is a member. In another scenario, a GroupReward card is issued by the Service Provider to users and also swiped at a Point-of-Sale terminal when the user makes a purchase at a participating Merchant Business in order to register the purchases with the online environment and Service Provider.

The participating Merchant Businesses establish their GroupReward sharing percentages within the online environment of certain embodiments, thereby determining the percentage of a qualified purchase that is to be paid by the Merchant Business to the groups in which a member belongs. For example, a local coffee shop may decide to allocate 3% of qualified purchases to participating groups in the form of a GroupReward payment. As another example, a larger merchant such as American Airlines or Safeway might choose to allocate 5% toward GroupReward payments. The online environment of certain embodiments enables a Service Provider to receive Point-of-Sale transaction information based on GroupReward or other cards registered by the user from one or more third-party vendors offering Point-of-Sale transaction processing.

The online environment of certain embodiments can process, store, and report on purchases per group, merchant business, or user. A Service Provider can generate periodic reports in order to invoice Merchant Businesses for GroupReward payments and to then allocate those payments to the groups themselves. In addition, a group's participation levels in advertising and marketing programs within the online environment website can be summarized and the appropriate revenue sharing allocated from the Service Provider to the group. The GroupReward and revenue sharing payments can then be made offline or online directly into a group's Virtual Transaction Account or transferred into a group bank account or Payment Service that has been linked to the online environment for processing online group payments.

As part of the GoLocal feature, a Service Provider can offer additional marketing or promotional services to merchant businesses enabling them to link promotions to GroupReward or other user payment cards. As an example, a local coffee shop may wish to offer a 2-for-1 breakfast promotion to members of all local school organizations within a 10 mile radius of the shop for a 30 day period one time per person. The online environment of certain embodiments can enable the merchant to target specific types of groups and geographies, create their marketing or promotional offer, and then present the marketing or promotional offer to the selected target audience through the online environment website. When a qualified member presents one of the registered payment cards (e.g., GroupReward card or credit card) to the merchant, the process of swiping the card into a Point-of-Sale terminal will allow the merchant to determine if the user/purchaser is qualified to receive the 2-for-1 promotion, for example. The online environment of certain embodiments can track a user's usage of specific marketing and advertising campaigns in conjunction with a third-party Point-of-Sale transaction processing vendor in order to qualify them for specific promotions during certain periods of time (e.g., only one 2-for-1 breakfast per month or per year).

Most of the GroupReward and GoLocal features can be implemented in an online manner via the online environment of certain embodiments in conjunction with a Service Provider instance. The online environment may include the following features, according to certain embodiments:
Support for merchant businesses to register themselves in the online environment, to determine marketing services, to determine target groups and/or geographies, to determine GroupReward sharing percentages, to create basic merchant business marketing and promotional materials, and to manage all of the above dynamically within the online environment website;
Support for online invoicing and payment collection from merchant businesses;
Support for merchant businesses to create targeted marketing and advertising materials and programs, and to link the merchant businesses to user's GroupReward card or other registered payment cards;
Support for group administration and reporting of GroupReward and GoLocal participation and group revenue allocations;
Support for group approval and filtering of merchant businesses and merchant advertising and promotions;
Support for an electronic interface to one or more third party Point-of-Sale transaction processing vendors enabling management of participating merchant businesses, tracking of user-registered payment and GroupReward cards, tracking merchant-specific marketing promotions and individual user applicability and usage of the promotions so that Point-of-Sale transactions can either be approved or rejected, tracking GroupReward revenue sharing per individual, allocating a user's GroupReward revenues to the applicable groups for which they have memberships;
Support for electronic invoicing and collections of advertising, marketing, and promotional service fees, and GroupReward payments from merchant businesses;
Support for electronic fund transfers or payments to Virtual Transaction Accounts or bank accounts for groups.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

We claim:

1. A method comprising:
providing an online environment for creating at least one community network including:
providing a hierarchy creation mechanism to create a plurality of groups organized in a hierarchy associated with the at least one community network;
providing inheritance of attributes between respective groups at different levels;
enabling a respective group in the at least one community network to manage a plurality of features associated with the respective 11 group; and
providing a secure work space in the respective group of the at least one community network.

2. The method of claim 1, further comprising automatically providing a respective member of the at least one community network an online identity to leverage the online identity for joining other community networks in the online environment.

3. The method of claim 1, further comprising automatically extending existing group policies, membership and attributes to newly created groups in the at least one community network.

4. The method of claim 1, wherein providing inheritance of attributes further comprises enabling newly created groups to inherit behavior and appearance of content from existing groups, wherein content comprises one or more of news, requests of needs, events, payment requests and advertising.

5. The method of claim 1, further including as attributes one or more features selected from the group consisting of:
a group membership list for a respective group;
membership access rights for the respective group;
a sub-group membership list for a sub-group of the respective group and associated default roles and access rights, wherein the sub-group membership list is a subset of the group membership list;
default logo;
default font;
access rights for filtering advertisements in the second group;
access rights for filtering merchants in the second group;
a first set of rules for filtering advertisements in the second group;
a second set of rules for featuring advertisements in the second group;
a third set of rules for filtering merchants in the second group;
a fourth set of rules for featuring merchants in the second group;
permission for overriding inherited attributes in the second group;
payment functionality, procedures, and a first infrastructure for handling payments in the second group;
advertising revenue functionality and a second infrastructure for handling advertising revenue in the second group;
default calendar themes and default calendar functionality for the first and second group;
default group dashboard set-up settings for content created in the second group; and
default group home page set-up settings for content created in the second group.

6. The method of claim 1, further comprising providing a revenue management mechanism for sharing, with the respective group, revenue generated from advertisements appearing in the respective group.

7. The method of claim 1, further comprising providing an advertising access mechanism for enabling advertisers to access target groups in the at least one community network for sending targeted advertising data.

8. The method of claim 1, further comprising providing a reward and promotion mechanism for enabling point-of-sale donations associated with the respective member's purchase to accrue to one or more of: a community network designated by the respective member and the at least one community network group.

9. The method of claim 1, further comprising providing a mechanism to filter and approve advertisements for the respective group by authorized members in the respective group

10. The method of claim 1, further comprising providing a payment mechanism to enable one or more of: online member-to-group payments, online member-to-member payments, and online group-to-member payments and reimbursements.

11. The method of claim 1, further comprising providing online reports, of payments and payment transactions, reimbursements, and money transfers on web pages in the respective group to authorized members.

12. The method of claim 11, further comprising enabling selection of reporting formats including formats that are compatible with third party accounting software.

13. The method of claim 1, further comprising providing to the respective member, one or more items associated with the respective group selected from a group consisting of:
an online payment request summary;
a payment history; and
customizable alerts.

14. The method of claim 1, further comprising:
providing a group dashboard and a group calendar associated with the respective group;
allowing authorized members of the respective group to customize dashboard themes and dashboard views for the group dashboard; and
allowing the authorized members of the respective group to customize calendar themes and calendar views for the group calendar.

15. The method of claim 1, further comprising prioritizing visibility of content on a group dashboard associated with the respective group by:
enabling a content owner associated with the respective group to assign a priority rating to a respective content item;
enabling the content owner to assign a due date, if any, for the respective content item;
enabling the content owner to assign a publish date for the respective content item;
enabling the content owner to assign start and end dates for the respective content item; and
wherein the content comprises one or more of news, requests of needs, events, payment requests and advertising.

16. The method of claim 1, further comprising:
providing a personal dashboard and a personal calendar for the respective member;
allowing the respective member to customize dashboard themes and dashboard views for the personal dashboard; and
allowing the respective member to customize calendar themes and calendar views for the personal calendar.

17. The method of claim 1, further comprising:
aggregating content from multiple groups, in which the respective member has membership, across a plurality of community networks associated with the online environment into a personal dashboard for the respective member;
prioritizing visibility of the content on the personal dashboard by enabling the respective member to assign respective priority ratings to the multiple groups for content originating from the multiple groups; and
wherein the content comprises one or more of news, requests of needs, events, payment requests and advertising.

18. The method of claim 1, further enabling customization of one or more features associated with the respective group from a set of features comprising:
content visual characteristics of content including text and graphics associated with the respective group;
web page visual characteristics of a plurality of web pages associated with the respective group; and
functionality of the plurality of web pages associated with the respective group.

19. The method of claim 1, further comprising providing a registration mechanism to enable the respective member to re-use an associated member profile and associated registration information for secure registering with other community networks that the respective member is interested in joining in the online environment.

20. The method of claim 17, further comprising enabling viewing, by the respective member on the personal dashboard of the respective member, event information that is specific to the respective member, the event information comprising:
an event list;
an event summary; and
a detailed description of a respective event from the event list.

21. The method of claim 20, further comprising enabling:
synchronizing one or more of: the event summary and the detailed description of the respective event, to a personal device of the respective member; and
printing by the respective user of one or more of: the event summary and the detailed description of the respective event.

22. The method of claim 1, further comprising providing a proxy mechanism for enabling an agent relationship between a first respective member and a second respective member, wherein the second respective member acquires selected access privileges and acts as an agent on behalf of the first respective member.

23. The method of claim 1, further comprising:
creating a set of default agent relationships with customized roles, customized access privileges, and customized viewing capabilities; and
allowing respective members to select and use one or more of the default agent relationships.

24. The method of claim 22, further comprising providing a directory membership listing information including a listing of agent relationships, if any.

25. The method of claim 22, further comprising providing to the agent a dashboard where displayed content is based on one or more of:
a first content that is associated with a role of agent;
a second content that is associated with the second respective member.

26. The method of claim 22, further comprising providing customized processing of requests from the agent based on a customized role of the agent.

27. The method of claim 1, further comprising providing a group homepage for public viewing by both non-members and members of the respective group and allowing authorized members of the respective group to control content of the group homepage.

28. The method of claim 1, further comprising storing member-controlled information that is associated with individual member, wherein the member-controlled information is for access by the plurality groups and wherein the access is specified by the individual member.

29. The method of claim 28, further comprising:
including as member-controlled information contact information of the individual member; and
enabling the individual member to select one or more contact information fields that are to be shared with one or more specified groups of the plurality groups.

30. The method of claim 1, further comprising enabling authorized members in the respective group to remove members based on polices set by the respective.

31. The method of claim 1, further comprising enabling authorized members in the respective group to remove members based on polices set by the online environment.

32. The method of claim 1, further comprising providing support tools for use by the respective group wherein the support tools include tools for tracking, editing and resolving trouble tickets.

33. The method of claim 32, wherein the support tools enables escalating unresolved trouble tickets to the online environment for resolution.

34. A computer system comprising:
a display;
a main memory;
a processor; and
at least one program stored in the main memory and executed by the processor, the at least one program including:
instructions for providing an online environment for creating at least one community network including:
instructions for providing a hierarchy creation mechanism to create a plurality of groups organized in a hierarchy associated with the at least one community network;
instructions for providing inheritance of attributes between respective groups at different levels;
instructions for enabling a respective group in the at least one community network to manage a plurality of features associated with the respective group; and
instructions for providing a secure work space in the respective group of the at least one community network.

35. The computer system of claim 34, further comprising instructions for automatically providing a respective member of the at least one community network an online identity to leverage the online identity for joining other community networks in the online environment.

36. The computer system of claim 34, further comprising instructions for automatically extending existing group policies, membership and attributes to newly created groups in the at least one community network.

37. The computer system of claim 34, wherein instructions for providing inheritance of attributes further comprises instructions for enabling newly created groups to inherit behavior and appearance of content from existing groups, wherein content comprises one or more of news, requests of needs, events, payment requests and advertising.

38. The computer system of claim 34, further including as attributes one or more features selected from the group consisting of:
a group membership list for a respective group;
membership access rights for the respective group;
a sub-group membership list for a sub-group of the respective group and associated default roles and access rights, wherein the sub-group membership list is a subset of the group membership list;
default logo;
default font;
access rights for filtering advertisements in the second group;
access rights for filtering merchants in the second group;
a first set of rules for filtering advertisements in the second group;
a second set of rules for featuring advertisements in the second group;
a third set of rules for filtering merchants in the second group;
a fourth set of rules for featuring merchants in the second group;
permission for overriding inherited attributes in the second group;
payment functionality, procedures, and a first infrastructure for handling payments in the second group;
advertising revenue functionality and a second infrastructure for handling advertising revenue in the second group;
default calendar themes and default calendar functionality for the first and second group;
default group dashboard set-up settings for content created in the second group; and
default group home page set-up settings for content created in the second group.

39. The computer system of claim 34, further comprising instructions for providing a revenue management mechanism for sharing, with the respective group, revenue generated from advertisements appearing in the respective group.

40. The computer system of claim 34, further comprising instructions for providing an advertising access mechanism for enabling advertisers to access target groups in the at least one community network for sending targeted advertising data.

41. The computer system of claim 34, further comprising instructions for providing a reward and promotion mechanism for enabling point-of-sale donations associated with the respective member's purchase to accrue to one or more of: a community network designated by the respective member and the at least one community network group.

42. The computer system of claim 34, further comprising instructions for providing a mechanism to filter and approve advertisements for the respective group by authorized members in the respective group

43. The computer system of claim 34, further comprising instructions for providing a payment mechanism to enable one or more of: online member-to-group payments, online member-to-member payments, and online group-to-member payments and reimbursements.

44. The computer system of claim 34, further comprising instructions for providing online reports, of payments and payment transactions, reimbursements, and money transfers on web pages in the respective group to authorized members.

45. The computer system of claim 44, further comprising instructions for enabling selection of reporting formats including formats that are compatible with third party accounting software.

46. The computer system of claim 34, further comprising instructions for providing to the respective member, one or more items associated with the respective group selected from a group consisting of:
an online payment request summary;
a payment history; and
customizable alerts.

47. The computer system of claim 34, further comprising:
instructions for providing a group dashboard and a group calendar associated with the respective group;
instructions for allowing authorized members of the respective group to customize dashboard themes and dashboard views for the group dashboard; and
instructions for allowing the authorized members of the respective group to customize calendar themes and calendar views for the group calendar.

48. The computer system of claim 34, further comprising instructions for prioritizing visibility of content on a group dashboard associated with the respective group by:
enabling a content owner associated with the respective group to assign a priority rating to a respective content item;
enabling the content owner to assign a due date, if any, for the respective content item;
enabling the content owner to assign a publish date for the respective content item;
enabling the content owner to assign start and end dates for the respective content item; and
wherein the content comprises one or more of news, requests of needs, events, payment requests and advertising.

49. The computer system of claim 34, further comprising:
instructions for providing a personal dashboard and a personal calendar for the respective member;
instructions for allowing the respective member to customize dashboard themes and dashboard views for the personal dashboard; and
instructions for allowing the respective member to customize calendar themes and calendar views for the personal calendar.

50. The computer system of claim 34, further comprising:
instructions for aggregating content from multiple groups, in which the respective member has membership, across a plurality of community networks associated with the online environment into a personal dashboard for the respective member;
instructions for prioritizing visibility of the content on the personal dashboard by enabling the respective member to assign respective priority ratings to the multiple groups for content originating from the multiple groups; and
wherein the content comprises one or more of news, requests of needs, events, payment requests and advertising.

51. The computer system of claim 34, further comprising instructions for enabling customization of one or more features associated with the respective group from a set of features comprising:
content visual characteristics of content including text and graphics associated with the respective group;
web page visual characteristics of a plurality of web pages associated with the respective group; and
functionality of the plurality of web pages associated with the respective group.

52. The computer system of claim 34, further comprising instructions for providing a registration mechanism to enable the respective member to re-use an associated member profile and associated registration information for secure registering with other community networks that the respective member is interested in joining in the online environment.

53. The computer system of claim 50, further comprising instructions for enabling viewing, by the respective member on the personal dashboard of the respective member, event information that is specific to the respective member, the event information comprising:
an event list;
an event summary; and
a detailed description of a respective event from the event list.

54. The computer system of claim 53, further comprising instructions for enabling:
synchronizing one or more of: the event summary and the detailed description of the respective event, to a personal device of the respective member; and
printing by the respective user of one or more of: the event summary and the detailed description of the respective event.

55. The computer system of claim 34, further comprising instructions for providing a proxy mechanism for enabling an agent relationship between a first respective member and a second respective member, wherein the second respective member acquires selected access privileges and acts as an agent on behalf of the first respective member.

56. The computer system of claim 34, further comprising:
instructions for creating a set of default agent relationships with customized roles, customized access privileges, and customized viewing capabilities; and
instructions for allowing respective members to select and use one or more of the default agent relationships.

57. The computer system of claim 55, further comprising instructions for providing a directory membership listing information including a listing of agent relationships, if any.

58. The computer system of claim 55, further comprising instructions for providing to the agent a dashboard where displayed content is based on one or more of:
a first content that is associated with a role of agent;
a second content that is associated with the second respective member.

59. The computer system of claim 55, further comprising instructions for providing customized processing of requests from the agent based on a customized role of the agent.

60. The computer system of claim 34, further comprising instructions for providing a group homepage for public viewing by both non-members and members of the respective group and allowing authorized members of the respective group to control content of the group homepage.

61. The computer system of claim 34, further comprising instructions for storing member-controlled information that is associated with individual member, wherein the member-controlled information is for access by the plurality groups and wherein the access is specified by the individual member.

62. The computer system of claim 61, further comprising:
instructions for including as member-controlled information contact information of the individual member; and
instructions for enabling the individual member to select one or more contact information fields that are to be shared with one or more specified groups of the plurality groups.

63. The computer system of claim 34, further comprising instructions for enabling authorized members in the respective group to remove members based on polices set by the respective.

64. The computer system of claim 34, further comprising instructions for enabling authorized members in the respective group to remove members based on polices set by the online environment.

65. The computer system of claim 34, further comprising instructions for providing support tools for use by the respective group wherein the support tools include tools for tracking, editing and resolving trouble tickets.

66. The computer system of claim 65, wherein the support tools enables escalating unresolved trouble tickets to the online environment for resolution.
